(19) United States
(12) Patent Application Publication
(10) Pub. No.: US 2026/0331042 A1
(43) Pub. Date: Oct. 22, 2026

(54) Pixel Driving Circuit, Driving Method therefor, and Display Apparatus

(71) Applicants: Hefei BOE Joint Technology Co.,Ltd., Hefei, Anhui (CN); BOE Technology Group Co., Ltd., Beijing (CN)

(72) Inventors: Xuehuan FENG, Beijing (CN); Yongqian LI, Beijing (CN)

(21) Appl. No.: 18/848,529

(22) PCT Filed: Dec. 14, 2023
(86) PCT No.: PCT/CN2023/138881

§ 371 Date: Sep. 19, 2024

(51) Int. Cl. G09G 3/3233; G09G 3/3266

(52) U.S. Cl. CPC G09G 3/3233; G09G 3/3266; G09G 2300/0819; G09G 2300/0852; G09G 2300/0861; G09G 2310/08

(57) ABSTRACT

A pixel driving circuit, a driving method thereof, and display apparatus. The pixel driving circuit includes: a first node control sub-circuit configured to provide a signal of a first initial signal terminal to first node under control of signals of first and second scan signal terminals, and change a signal of first node by a signal of second node; and a second node control sub-circuit configured to change signal of second node by a signal of writing signal terminal under control of signals of at least one scan signal terminal and voltage stabilizing signal terminal. The first node control sub-circuit includes at least one capacitor, second node control sub-circuit includes at least two capacitors and at least one transistor, at least one capacitor in first node control sub-circuit is electrically connected to at least one transistor in second node control sub-circuit through at least one capacitor in second node control sub-circuit.

### CROSS-REFERENCE TO RELATED APPLICATION

The present application is a U.S. National Phase Entry of International Application No. PCT/CN2023/138881 having an international filing date of Dec. 14, 2023, the content of which is hereby incorporated by reference.

### TECHNICAL FIELD

The present disclosure relates to, but is not limited to, the field of display technology, and in particular to a pixel driving circuit, a driving method therefor and a display apparatus.

### BACKGROUND

An Organic Light Emitting Diode (OLED for short) and a Quantum dot Light Emitting Diode (QLED for short) are active light emitting display devices and have advantages such as self-luminescence, wide viewing angle, high contrast ratio, low power consumption, very high response speed, lightness and thinness, flexibility, and low cost. With constant development of display technologies, a flexible display apparatus (Flexible Display) in which an OLED or a QLED is used as a light emitting device and signal control is performed through a Thin Film Transistor (TFT for short) has become a mainstream product in the field of display at present.

### SUMMARY

The following is a summary of the subject matter described in detail in the present application. This summary is not intended to limit the protection scope of claims.

In a first aspect, the present application discloses a pixel driving circuit, which includes: a first node control sub-circuit, a second node control sub-circuit and a driving sub-circuit.

The driving sub-circuit is electrically connected to a first node, a second node, and a third node respectively, and is configured to provide a driving signal to the second node under control of signals of the first node and the third node.

The first node control sub-circuit is electrically connected with a first scan signal terminal, a second scan signal terminal, a first initial signal terminal, the first node and the second node, respectively, and is configured to provide a signal of the first initial signal terminal to the first node under control of signals of the first scan signal terminal and the second scan signal terminal, and change a signal of the first node by a signal of the second node.

The second node control sub-circuit is electrically connected to at least one scan signal terminal, the second node, a voltage stabilizing signal terminal and a writing signal terminal respectively, and is configured to change the signal of the second node by a signal of the writing signal terminal under control of signals of the at least one scan signal terminal and the voltage stabilizing signal terminal.

The writing signal terminal includes: a data signal terminal and a reference signal terminal, or the writing signal terminal is a data signal terminal in at least a part of a time period, and is a reference signal terminal in at least another part of a time period.

The first node control sub-circuit includes at least one capacitor, the second node control sub-circuit includes at least two capacitors and at least one transistor, and the at least one capacitor in the first node control sub-circuit is electrically connected to the at least one transistor in the second node control sub-circuit by at least one capacitor in the second node control sub-circuit.

In an exemplary implementation, the pixel driving circuit also includes an anode reset sub-circuit and a light emitting control sub-circuit.

The anode reset sub-circuit is electrically connected to a third scan signal terminal, a second initial signal terminal and a fourth node, respectively, and is configured to provide a signal of the second initial signal terminal to the fourth node under control of a signal of the third scan signal terminal.

The light emitting control sub-circuit is electrically connected to a first light emitting signal terminal, a second light emitting signal terminal, a first power supply terminal, the second node, the third node, and the fourth node, respectively, and is configured to provide a signal of the first power supply terminal to the third node and a signal of the second node to the fourth node under control of signals of the first light emitting signal terminal and the second light emitting signal terminal.

In an exemplary implementation, the first node control sub-circuit includes a node reset sub-circuit and a node compensation sub-circuit.

The node reset sub-circuit is electrically connected to the first scan signal terminal, the first initial signal terminal and the first node, respectively, and is configured to provide a signal of the first initial signal terminal to the first node under control of a signal of the first scan signal terminal.

The node compensation sub-circuit is electrically connected to the first node, the second node and the second scan signal terminal, respectively, and is configured to change the signal of the first node by the signal of the second node under control of the signal of the second scan signal terminal.

In an exemplary implementation, the node reset sub-circuit includes: a first transistor; a control electrode of the first transistor is electrically connected to the first scan signal terminal, a first electrode of the first transistor is electrically connected to the first initial signal terminal, and a second electrode of the first transistor is electrically connected to the first node.

In an exemplary implementation, the node compensation sub-circuit includes a first capacitor and a second transistor; one terminal of the first capacitor is electrically connected to the first node, and the other terminal of the first capacitor is electrically connected to a first electrode of the second transistor; a control electrode of the second transistor is electrically connected to the second scan signal terminal, and a second electrode of the second transistor is electrically connected to the second node.

In an exemplary implementation, the node compensation sub-circuit includes a first capacitor and a second transistor; one terminal of the first capacitor is electrically connected to the second node, and the other terminal of the first capacitor is electrically connected to a second electrode of the second transistor; a control electrode of the second transistor is electrically connected to the second scan signal terminal, and a first electrode of the second transistor is electrically connected to the first node.

In an exemplary implementation, the node compensation sub-circuit includes a first capacitor, a second transistor, and a fourth capacitor; one terminal of the first capacitor is electrically connected to the first node, and the other terminal of the first capacitor is electrically connected to a first electrode of the second transistor; one terminal of the fourth capacitor is electrically connected to the second node, and the other terminal of the fourth capacitor is electrically connected to a second electrode of the second transistor; a control electrode of the second transistor is electrically connected to the second scan signal terminal.

In an exemplary implementation, the first scan signal terminal and the second scan signal terminal are different signal terminals or are the same signal terminal.

In an exemplary implementation, when the writing signal terminal is a data signal terminal in at least a part of the time period and a reference signal terminal in at least another part of the time period, the at least one scan signal terminal includes a fourth scan signal terminal, and the second node control sub-circuit is electrically connected to the fourth scan signal terminal, the second node, the voltage stabilizing signal terminal and the writing signal terminal, respectively.

In an exemplary implementation, the second node control sub-circuit includes a second capacitor, a third capacitor, and a fourth transistor; one terminal of the second capacitor is electrically connected to the voltage stabilizing signal terminal, and the other terminal of the second capacitor is electrically connected to the second node; one terminal of the third capacitor is electrically connected to the second node, and the other terminal of the third capacitor is electrically connected to the fifth node; a control electrode of the fourth transistor is electrically connected to the fourth scan signal terminal, a first electrode of the fourth transistor is electrically connected to the writing signal terminal, and a second electrode of the fourth transistor is electrically connected to the fifth node.

In an exemplary implementation, the third scan signal terminal and the fourth scan signal terminal are different signal terminals or are the same signal terminal.

In an exemplary implementation, when the writing signal terminal includes a data signal terminal and a reference signal terminal, the at least one scan signal terminal includes a fourth scan signal terminal and a fifth scan signal terminal, and the second node control sub-circuit is electrically connected to the fourth scan signal terminal, the fifth scan signal terminal, the second node, the voltage stabilizing signal terminal, the reference signal terminal and the data signal terminal, respectively.

In an exemplary implementation, the second node control sub-circuit includes a second capacitor, a third capacitor, a fourth transistor, and an eighth transistor; one terminal of the second capacitor is electrically connected to the voltage stabilizing signal terminal, and the other terminal of the second capacitor is electrically connected to the second node; one terminal of the third capacitor is electrically connected to the second node, and the other terminal of the third capacitor is electrically connected to the fifth node; a control electrode of the fourth transistor is electrically connected to the fourth scan signal terminal, a first electrode of the fourth transistor is electrically connected to the reference signal terminal, and a second electrode of the fourth transistor is electrically connected to the fifth node; a control electrode of the eighth transistor is electrically connected to the fifth scan signal terminal, a first electrode of the eighth transistor is electrically connected to the data signal terminal, and a second electrode of the eighth transistor is electrically connected to the fifth node.

In an exemplary implementation, the third scan signal terminal, the fourth scan signal terminal, and the fifth scan signal terminal are different signal terminals.

In an exemplary implementation, the driving sub-circuit includes a third transistor, the light emitting control sub-circuit includes a fifth transistor and a sixth transistor, and the anode reset sub-circuit includes a seventh transistor.

A control electrode of the third transistor is electrically connected to the first node, a first electrode of the third transistor is electrically connected to the third node, and a second electrode of the third transistor is electrically connected to the second node.

A control electrode of the fifth transistor is electrically connected to the first light emitting signal terminal, a first electrode of the fifth transistor is electrically connected to the first power supply terminal, and a second electrode of the fifth transistor is electrically connected to the third node.

A control electrode of the sixth transistor is electrically connected to the second light emitting signal terminal, a first electrode of the sixth transistor is electrically connected to the second node, and a second electrode of the sixth transistor is electrically connected to the fourth node.

A control electrode of the seventh transistor is electrically connected to the third scan signal terminal, a first electrode of the seventh transistor is electrically connected to the second initial signal terminal, and a second electrode of the seventh transistor is electrically connected to the fourth node.

In an exemplary implementation, the pixel driving circuit includes a plurality of transistors, at least one transistor in the pixel driving circuit is an N-type transistor.

In a second aspect, the present disclosure also provides a display apparatus including the pixel driving circuit described above.

In the exemplary implementation, the display apparatus further includes a scan driving circuit, the scan driving circuit is electrically connected to a first scan signal terminal, a second scan signal terminal, a third scan signal terminal, a first light emitting signal terminal, and a second light emitting signal terminal electrically connected to the pixel driving circuit, respectively; herein the scan driving circuit is configured to: provide an effective level signal to the second light emitting signal terminal, the first scan signal terminal, the second scan signal terminal, and the third scan signal terminal, and provide an ineffective level signal to the first light emitting signal terminal, in a first time period; provide an effective level signal to the first light emitting signal terminal, the first scan signal terminal, the second scan signal terminal, and the third scan signal terminal, and provide an ineffective level signal to the second light emitting signal terminal, in a second time period; provide an effective level signal to the third scan signal terminal, and provide an ineffective level signal to the first light emitting signal terminal, the second light emitting signal terminal, the first scan signal terminal and the second scan signal terminal, in a third time period; and provide an effective level signal to the first light emitting signal terminal and the second light emitting signal terminal, and provide an ineffective level signal to the first scan signal terminal, the second scan signal terminal and the third scan signal terminal, in a fourth time period.

Herein the first time period to the fourth time period lapse sequentially, and at least two time periods from the first time period to the fourth time period do not overlap.

In an exemplary implementation, an end time of the first time period is a start time of the second time period, an end time of the second time period is a start time of the third time period, and an end time of the third time period is a start time of the fourth time period.

In an exemplary implementation, the scan driving circuit is further electrically connected to a fourth scan signal terminal which is electrically connected to the pixel driving circuit, and the scan driving circuit is configured to: provide an effective level signal to the fourth scan signal terminal in the first time period to the third time period, and provide an ineffective level signal to the fourth scan signal terminal in the fourth time period.

In an exemplary implementation, the scan driving circuit is further electrically connected to a fourth scan signal terminal and a fifth scan signal terminal which are electrically connected to the pixel driving circuit, respectively; herein the scan driving circuit is configured to: provide an effective level signal to the fourth scan signal terminal, and provide an ineffective level signal to the fifth scan signal terminal, in the first and second time periods; provide an effective level signal to the fifth scan signal terminal, and provide an ineffective level signal to the fourth scan signal terminal, in the third time period; and provide an ineffective level signal to the fourth scan signal terminal and the fifth scan signal terminal in the fourth time period.

In an exemplary implementation, when the first scan signal terminal and the second scan signal terminal electrically connected to the pixel driving circuit are different signal terminals, the scan driving circuit includes: a first scan driving sub-circuit and a second scan driving sub-circuit; the first scan driving sub-circuit is electrically connected to the first scan signal terminal, and the second scan driving sub-circuit is electrically connected to the second scan signal terminal.

In an exemplary implementation, when the first scan signal terminal and the second scan signal terminal electrically connected to the pixel driving circuit are a same signal terminal, the scan driving circuit includes a first scan driving sub-circuit; the first scan driving sub-circuit is electrically connected to the first scan signal terminal and the second scan signal terminal, respectively.

In an exemplary implementation, at least one scan signal terminal electrically connected to a second node control sub-circuit is a fourth scan signal terminal, and when the third scan signal terminal and the fourth scan signal terminal electrically connected to the pixel driving circuit are different signal terminals, the scan driving circuit includes: a third scan driving sub-circuit and a fourth scan driving sub-circuit; the third scan driving sub-circuit is electrically connected to the third scan signal terminal, and the fourth scan driving sub-circuit is electrically connected to the fourth scan signal terminal.

In an exemplary implementation, at least one scan signal terminal electrically connected to a second node control sub-circuit is a fourth scan signal terminal, and when the third scan signal terminal and the fourth scan signal terminal electrically connected to the pixel driving circuit are the same signal terminal, the scan driving circuit includes a third scan driving sub-circuit; the third scan driving sub-circuit is electrically connected to the third scan signal terminal and the fourth scan signal terminal, respectively.

In an exemplary implementation, when at least one scan signal terminal electrically connected to a second node control sub-circuit is a fourth scan signal terminal and a fifth scan signal terminal, the scan driving circuit includes: a third scan driving sub-circuit, a fourth scan driving sub-circuit, and a fifth scan driving sub-circuit; the third scan driving sub-circuit is electrically connected to the third scan signal terminal, the fourth scan driving sub-circuit is electrically connected to the fourth scan signal terminal, and the fifth scan driving sub-circuit is electrically connected to the fifth scan signal terminal.

In a third aspect, the present disclosure further provides a method for driving a pixel driving circuit, the method is configured to drive the pixel driving circuit above-described, and the method includes:
providing, by the first node control sub-circuit, the signal of the first initial signal terminal to the first node under the control of the signals of the first scan signal terminal and the second scan signal terminal, and driving the signal of the first node by the signal of the second node;
changing, by the second node control sub-circuit, the signal of the second node by the signal of the writing signal terminal under the control of the signal of at least one scan signal terminal; and
providing, by the driving sub-circuit, the driving signal to the second node under control of signals of the first node and the third node.

In an exemplary implementation, the method further includes: providing, by the anode reset sub-circuit, the signal of the second initial signal terminal to the fourth node under the control of the signal of the third scan signal terminal; and providing, by the light emitting control sub-circuit, the signal of the first power supply terminal to the third node and the signal of the second node to the fourth node under control of signals of the first light emitting signal terminal and the second light emitting signal terminal;
Other aspects of the present disclosure may be comprehended after the drawings and the detailed descriptions are read and understood.

### BRIEF DESCRIPTION OF DRAWINGS

Accompanying drawings are used for providing an understanding of technical solutions of the present application and form a part of the specification, are used for explaining the technical solutions of the present application together with embodiments of the present application, and do not constitute a limitation on the technical solutions of the present application.

FIG. 1 is a schematic diagram of a structure of a pixel driving circuit according to an embodiment of the present disclosure.

FIG. 2 is a schematic diagram of a structure of a pixel driving circuit according to an exemplary implementation.

FIG. 3 is an equivalent circuit diagram of a node reset sub-circuit.

FIG. 4A is a first equivalent circuit diagram of a node compensation sub-circuit.

FIG. 4B is a second equivalent circuit diagram of the node compensation sub-circuit.

FIG. 4C is a third equivalent circuit diagram of the node compensation sub-circuit.

FIG. 5A is a first equivalent circuit diagram of a second node control sub-circuit.

FIG. 5B is a second equivalent circuit diagram of the second node control sub-circuit.

FIG. 6 is a partial equivalent circuit diagram of a pixel driving circuit.

FIG. 7 is a first equivalent circuit diagram of the pixel driving circuit.

FIG. 8 is a second equivalent circuit diagram of the pixel driving circuit.

FIG. 9 is a third equivalent circuit diagram of the pixel driving circuit.

FIG. 10 is a fourth equivalent circuit diagram of the pixel driving circuit.

FIG. 11 is a fifth equivalent circuit diagram of the pixel driving circuit.

FIG. 12 is a sixth equivalent circuit diagram of the pixel driving circuit.

FIG. 13 is an operating timing diagram of the pixel driving circuits provided in FIGS. 7 to 9.

FIG. 14 is an operating timing diagram of the pixel driving circuits provided in FIGS. 10 to 12.

FIG. 15 is a schematic diagram of a structure of a display apparatus.

FIG. 16 is a first schematic diagram of a scan driving circuit.

FIG. 17 is a second schematic diagram of the scan driving circuit.

FIG. 18 is a third schematic diagram of the scan driving circuit.

FIG. 19 is a fourth schematic diagram of the scan driving circuit.

FIG. 20 is a fifth schematic diagram of the scan driving circuit.

FIG. 21 is a sixth schematic diagram of the scan driving circuit.

### DETAILED DESCRIPTION

To make the objectives, technical solutions, and advantages of the present disclosure clearer, the embodiments of the present disclosure will be described in detail below with reference to the accompany drawings. It is to be noted that implementation modes may be implemented in multiple different forms. Those of ordinary skills in the art can easily understand such a fact that implementation modes and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict. In order to keep following description of the embodiments of the present disclosure clear and concise, detailed description of part of known functions and known components are omitted in the present disclosure. The drawings of the embodiments of the present disclosure only involve structures involved in the embodiments of the present disclosure, and for other structures, reference may be made to conventional designs.

Scales of the drawings in the present disclosure may be used as a reference in actual processes, but are not limited thereto. For example, a width-length ratio of a channel, a thickness and spacing of each film, and a width and spacing of each signal line may be adjusted according to actual needs. A quantity of pixels in a display substrate and a quantity of sub-pixels in each pixel are not limited to the quantities shown in the drawings. The drawings described in the present disclosure are schematic structural diagrams only, and one implementation mode of the present disclosure is not limited to shapes, numerical values, or the like shown in the drawings.

Ordinal numerals “first”, “second”, “third”, etc., in the specification are set not to form limits in numbers but only to avoid confusion between composition elements.

In the specification, for convenience, expressions “central”, “above”, “below”, “front”, “back”, “vertical”, “horizontal”, “top”, “bottom”, “inside”, “outside”, etc., indicating directional or positional relationships are used to illustrate positional relationships between the composition elements with reference to the drawings, not to indicate or imply that involved devices or elements are required to have specific orientations and be structured and operated with the specific orientations but only to easily and simply describe the present specification, and thus should not be understood as limitations on the present disclosure. The positional relationships between the constituent elements may be changed as appropriate according to a direction according to which each constituent element is described. Therefore, appropriate replacements based on situations are allowed, which is not limited to the expressions in the specification.

In the specification, unless otherwise specified and defined, terms “mounting”, “mutual connection”, and “connection” should be understood in a broad sense. For example, it may be a fixed connection, a detachable connection, or an integral connection; it may be a mechanical connection or a connection; it may be a direct connection, an indirect connection through a middleware, or an internal communication inside two elements. Those of ordinary skills in the art may understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, a “connection” includes a case where composition elements are connected together through an element with a certain electrical action. An “element with a certain electrical action” is not particularly limited as long as electrical signals between the connected constituent elements may be sent and received. Examples of the “element with the certain electrical action” not only include an electrode and a wiring, but also include a switching element such as a transistor, a resistor, an inductor, a capacitor, another element with various functions, etc.

In the specification, “arranged in a same layer” described refers to a structure formed by patterning two (or more than two) structures through a same patterning process, and their materials may be the same or different. For example, materials of precursors for forming multiple structures arranged in a same layer are the same, and final materials may be the same or different.

With development of OLED display technologies, oxide process is often applied in OLED display products because of its high uniformity. The accuracy of the internal compensation of the pixel driving circuit prepared by the oxide process is not high, which makes the stability of the pixel driving circuit relatively low.

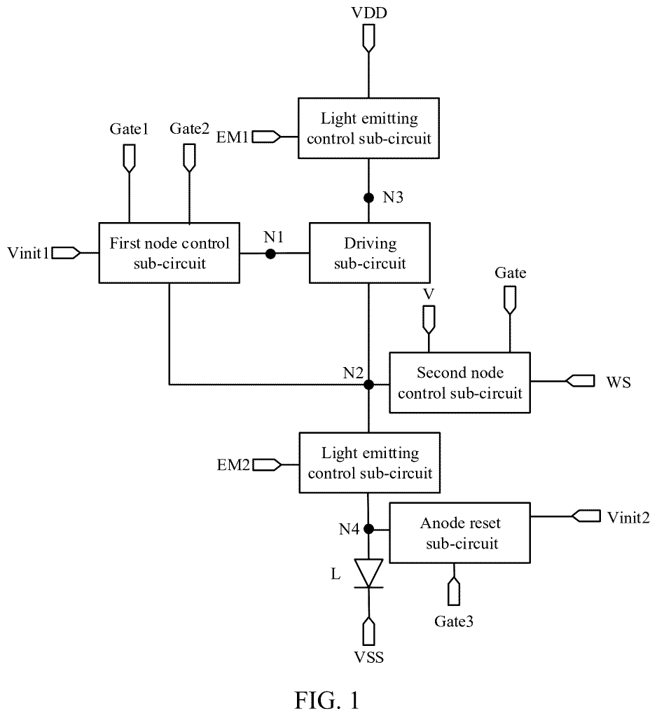

FIG. 1 is a schematic diagram of a structure of a pixel driving circuit according to an embodiment of the present disclosure. As shown in FIG. 1, a pixel driving circuit provided by an embodiment of the present disclosure may include: a first node control sub-circuit, a second node control sub-circuit and a driving sub-circuit. Herein the driving sub-circuit is connected to a first node N1, a second node N2, and a third node N3, respectively, and is configured to provide a driving signal to the second node N2 under control of signals from the first node N1 and the third node N3. The first node control sub-circuit is connected to a first scan signal terminal Gate1, a second scan signal terminal Gate2, a first initial signal terminal Vinit1, the first node N1 and the second node N2, respectively, and is configured to, under control of signals of the first scan signal terminal Gate1 and the second scan signal terminal Gate2, provide a signal of the first initial signal terminal Vinit1 to the first node N1 and change a signal of the first node N1 by a signal of the second node N2. The second node control sub-circuit is respectively connected with at least one scan signal terminal Gate, the second node N2, a voltage stabilizing signal terminal V and a writing signal terminal WS, and is configured to change the signal of the second node N2 by a signal of the writing signal terminal WS under control of signals of the at least one scan signal terminal Gate and the voltage stabilizing signal terminal V. Herein, the writing signal terminal WS includes: a data signal terminal and a reference signal terminal; or the writing signal terminal WS is a data signal terminal in at least a part of a time period, and is a reference signal terminal in at least another part of the time period.

In the present disclosure, the first node control sub-circuit includes at least one capacitor, the second node control sub-circuit includes at least two capacitors and at least one transistor, the at least one capacitor in the first node control sub-circuit is connected with at least one transistor in the second node control sub-circuit through at least one capacitor in the second node control sub-circuit, that is, at least one capacitor in the second node control sub-circuit separates the at least one capacitor in the first node control sub-circuit from the at least one transistor in the second node control sub-circuit.

In an exemplary implementation, the driving sub-circuit includes a driving transistor.

In an exemplary implementation, at least one transistor in the second node control sub-circuit may be configured to write a signal of the data signal terminal or write a signal of the reference signal terminal.

In an exemplary implementation, the voltage stabilizing signal terminal V may continuously provide a high-level signal or a low-level signal.

In an exemplary implementation, the first initial signal terminal Vinit1 continuously provides a low-level signal, and a signal of the first initial signal terminal Vinit1 may be a DC signal.

In an exemplary implementation, the reference signal terminal continuously provides a low-level signal, a signal of the reference signal terminal may be a DC signal, and exemplarily, a voltage of the signal of the reference signal terminal may be 0V.

In the present disclosure, the signal to be written to the second node may be controlled through distribution of at least two capacitors in the second node control sub-circuit, and then the signal of the first node may be controlled through the first node control sub-circuit, thereby realizing the compensation to the threshold voltage of the driving transistor in the driving sub-circuit, and improving the stability of the pixel driving circuit.

In an exemplary implementation as shown in FIG. 1, the pixel driving circuit may further include an anode reset sub-circuit and a light emitting control sub-circuit. Herein the anode reset sub-circuit is electrically connected to the third scan signal terminal Gate3, the second initial signal terminal Vinit2, and the fourth node N4, respectively, and is configured to provide a signal of the second initial signal terminal Vinit2 to the fourth node N4 under control of the signal of the third scan signal terminal Gate3. The light emitting control sub-circuit is electrically connected to the first light emitting signal terminal EM1, the second light emitting signal terminal EM2, the first power supply terminal VDD, the second node N2, the third node N3, and the fourth node N4, respectively, and is configured to provide a signal of the first power supply terminal VDD to the third node N3 and a signal of the second node N2 to the fourth node N4 under control of signals of the first light emitting signal terminal EM1 and the second light emitting signal terminal EM2.

In an exemplary implementation, the pixel driving circuit is configured to drive the light emitting device L to emit light, and as shown in FIG. 1, the light emitting device L is electrically connected to the fourth node N4 and a second power supply terminal VSS, respectively.

In an exemplary implementation, the first power supply terminal VDD continuously provides a high-level signal, and the signal of the first power supply terminal VDD is a Direct Current (DC) signal.

In an exemplary implementation, the second power supply terminal VSS continuously provides a low-level signal, and a signal of the second power supply terminal VSS is a DC signal.

In an exemplary implementation, a voltage value of the signal of the second initial signal terminal Vinit2 may be smaller than a voltage value of the signal of the second power supply terminal VSS, which can avoid wrong light emission of the light emitting device L and enhance the reliability of the pixel driving circuit.

In an exemplary implementation, the light emitting device L may include a first electrode (anode), an organic emitting layer, and a second electrode (cathode) that are stacked. Exemplarily, the anode of the light emitting device L is electrically connected to the fourth node N4, and the cathode of the light emitting device L is electrically connected to the second power supply terminal VSS.

In an exemplary implementation, the light emitting device L, which may include a current-driven device, may use a current-type light emitting diode, such as a micro light emitting diode (Micro LED), or a mini light emitting Diode (Mini LED), or an Organic light emitting diode (OLED), or a quantum light emitting diode (QLED). A typical size (e.g., length) of a Micro LED may be less than 100 μm, e.g., 10 μm to 50 μm. A typical size (e.g., length) of a Mini LED may be about 100 μm to 300 μm, e.g., 120 μm to 260 μm.

In an exemplary implementation, the organic emitting layer may include a Hole Injection Layer (HIL), a Hole Transport Layer (HTL), an Electron Block Layer (EBL), an Emitting Layer (EML), a Hole Block Layer (HBL), an Electron Transport Layer (ETL), and an Electron Injection Layer (EIL) that are stacked. In an exemplary implementation, Hole Injection Layers of all sub-pixels may be connected together to be a common layer, Electron Injection Layers of all the sub-pixels may be connected together to be a common layer, Hole Transport Layers of all the sub-pixels may be connected together to be a common layer, Electron Transport Layers of all the sub-pixels may be connected together to be a common layer, Hole Block Layers of all the sub-pixels may be connected together to be a common layer, Emitting Layers of adjacent sub-pixels may be overlapped slightly or may be isolated, and Electron Block Layers of adjacent sub-pixels may be overlapped slightly or may be isolated.

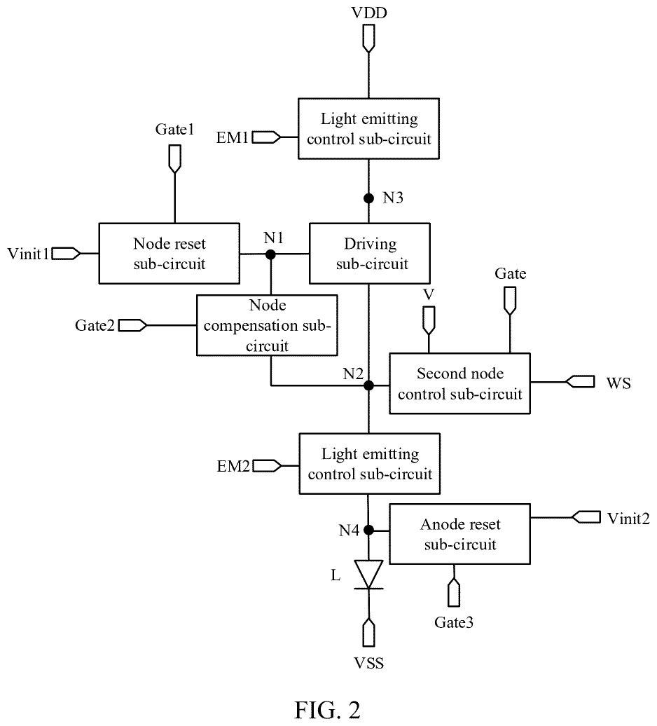

FIG. 2 is a schematic diagram of a structure of a pixel driving circuit according to an exemplary implementation. As shown in FIG. 2, in an exemplary implementation, the first node control sub-circuit may include a node reset sub-circuit and a node compensation sub-circuit. The node reset sub-circuit is electrically connected to the first scan signal terminal Gate1, the first initial signal terminal Vinit1 and the first node N1, respectively, and is configured to provide a signal of the first initial signal terminal Vinit1 to the first node N1 under control of a signal of the first scan signal terminal Gate1. The node compensation sub-circuit is electrically connected to the first node N1, the second node N2, and the second scan signal terminal Gate2, respectively, and is configured to change a signal of the first node N1 by the signal of the second node N2 under control of a signal of the second scan signal terminal Gate2.

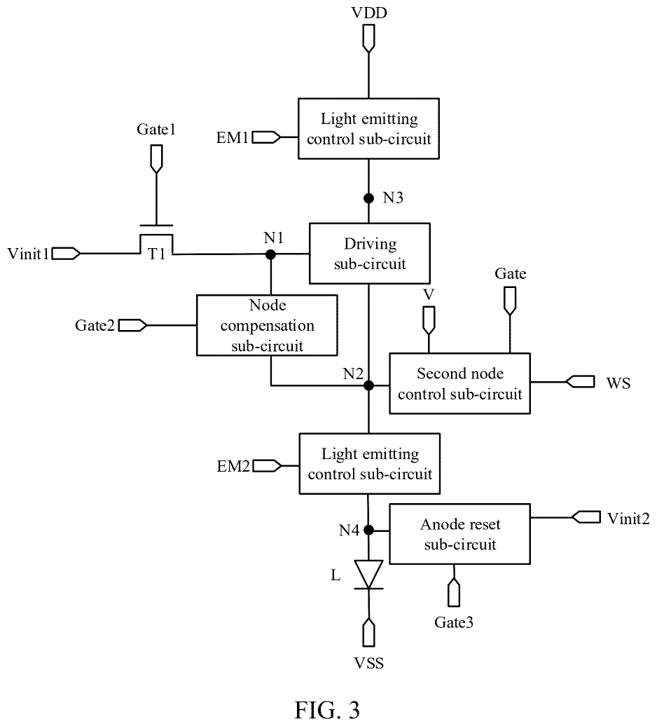

In an exemplary implementation, FIG. 3 is an equivalent circuit diagram of a node reset sub-circuit. As shown in FIG. 3, the node reset sub-circuit may include a first transistor T1. Herein, a control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1.

One exemplary structure of the node reset sub-circuit is just shown in FIG. 3, and it will be readily understood by those skilled in the art that implementation of the node reset sub-circuit is not limited thereto.

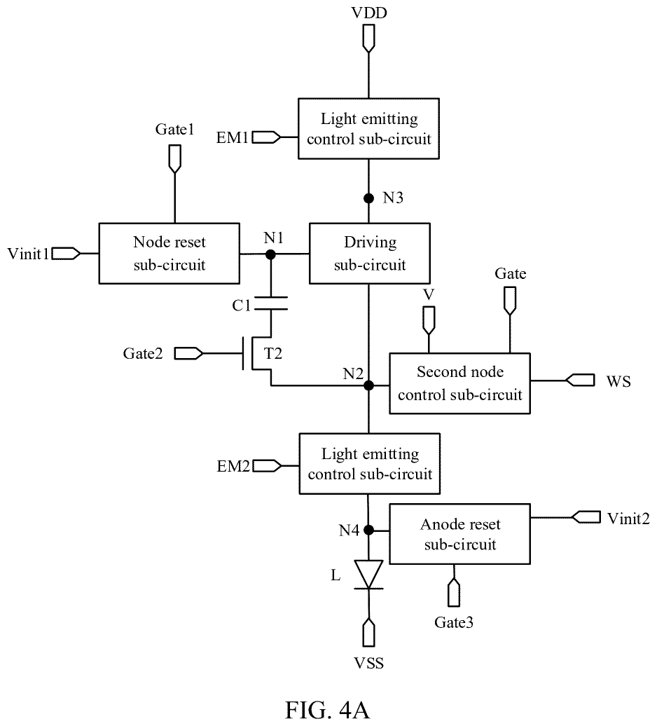

FIG. 4A is a first equivalent circuit diagram of the node compensation sub-circuit. As shown in FIG. 4A, in an exemplary implementation, the node compensation sub-circuit may include a first capacitor C1 and a second transistor T2. Herein, one terminal of the first capacitor C1 is electrically connected to the first node N1, and the other terminal of the first capacitor C1 is electrically connected to a first electrode of the second transistor T2; a control electrode of the second transistor T2 is electrically connected to the second scan signal terminal Gate2, and a second electrode of the second transistor T2 is electrically connected to the second node N2.

FIG. 4B is a second equivalent circuit diagram of the node compensation sub-circuit. As shown in FIG. 4B, in an exemplary implementation, the node compensation sub-circuit may include a first capacitor C1 and a second transistor T2. Herein, one terminal of the first capacitor C1 is electrically connected to the second node N2, and the other terminal of the first capacitor C1 is electrically connected to a second electrode of the second transistor T2; a control electrode of the second transistor T2 is electrically connected to the second scan signal terminal Gate2, and a first electrode of the second transistor T2 is electrically connected to the first node N1.

FIG. 4C is a third equivalent circuit diagram of the node compensation sub-circuit. As shown in FIG. 4C, in an exemplary implementation, the node compensation sub-circuit includes a first capacitor C1, a second transistor T2, and a fourth capacitor C4. Herein, one terminal of the first capacitor C1 is electrically connected to the first node N1, and the other terminal of the first capacitor C1 is electrically connected to a first electrode of the second transistor T2; one terminal of the fourth capacitor C4 is electrically connected to the second node N2, and the other terminal of the fourth capacitor C4 is electrically connected to a second electrode of the second transistor T2; and a control electrode of the second transistor T2 is electrically connected to the second scan signal terminal Gate2.

In an exemplary implementation, a time duration when the signal of the first scan signal terminal Gate1 is an effective level signal overlaps at least partially with a time duration when the signal of the second scan signal terminal Gate2 is an effective level signal, wherein the first scan signal terminal Gate1 and the second scan signal terminal Gate2 are electrically connected to the pixel driving circuit.

In an exemplary implementation, a time duration when the signal of the first scan signal terminal Gate1 is an effective level signal coincides with a time duration when the signal of the second scan signal terminal Gate2 is an effective level signal, wherein the first scan signal terminal Gate1 and the second scan signal terminal Gate2 are electrically connected to the pixel driving circuit.

In an exemplary implementation, the first scan signal terminal Gate1 and the second scan signal terminal Gate2 may be different signal terminals, or may be the same signal terminal.

Three exemplary structures of the node compensation sub-circuit are just shown in FIGS. 4A to 4C, and it will be readily understood by those skilled in the art that the implementation of the node compensation sub-circuit is not limited thereto.

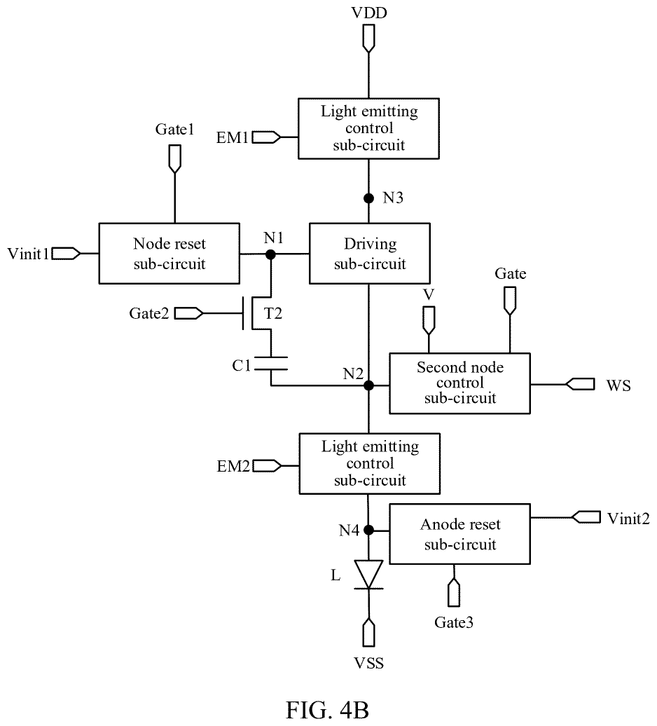

FIG. 5A is a first equivalent circuit diagram of the second node control sub-circuit. As shown in FIG. 5A, in an exemplary implementation, when the writing signal terminal WS is a data signal terminal for at least part of a time period and is a reference signal terminal for at least another part of the time period. The at least one scan signal terminal may include a fourth scan signal terminal Gate4. The second node control sub-circuit is electrically connected to the fourth scan signal terminal Gate4, the second node N2, the voltage stabilizing signal terminal V, and the writing signal terminal WS, respectively. The time duration when the writing signal terminal WS is the data signal terminal is not overlapped with the time duration when the writing signal terminal WS is the reference signal terminal.

In an exemplary implementation, as shown in FIG. 5A, the second node control sub-circuit may include a second capacitor C2, a third capacitor C3, and a fourth transistor T4. One terminal of the second capacitor C2 is electrically connected to the voltage stabilizing signal terminal V, and the other terminal of the second capacitor C2 is electrically connected to the second node N2; one terminal of the third capacitor C3 is electrically connected to the second node N2, and the other terminal of the third capacitor C3 is electrically connected to the fifth node N5; a control electrode of the fourth transistor T4 is electrically connected to the fourth scan signal terminal Gate4, a first electrode of the fourth transistor T4 is electrically connected to the writing signal terminal WS, and a second electrode of the fourth transistor T4 is electrically connected to the fifth node N5.

In the exemplary implementation, a time duration when the signal of the third scan signal terminal Gate3 is an effective level signal overlaps at least partially with a time duration when the signal of the fourth scan signal terminal Gate4 is an effective level signal, wherein the third scan signal terminal Gate3 and the fourth scan signal terminal Gate4 are electrically connected to the pixel driving circuit.

In the exemplary implementation, a time duration when the signal of the third scan signal terminal Gate3 is an effective level signal coincides with a time duration when the signal of the fourth scan signal terminal Gate4 is an effective level signal, wherein the third scan signal terminal Gate3 and the fourth scan signal terminal Gate4 are electrically connected to the pixel driving circuit.

In the exemplary implementation, a time duration when the signal of the first scan signal terminal Gate1 is an effective level signal overlaps at least partially with a time duration when the signal of the third scan signal terminal Gate3 is an effective level signal, and the time duration when the signal of the first scan signal terminal Gate1 is an effective level signal is within the time duration when the signal of the third scan signal terminal Gate3 is an effective level signal, wherein the first scan signal terminal Gate1 and the third scan signal terminal Gate3 are electrically connected to the pixel driving circuit.

In an exemplary implementation, the third scan signal terminal Gate3 and the fourth scan signal terminal Gate4 may be different signal terminals, or may be the same signal terminal.

FIG. 5B is a second equivalent circuit diagram of the second node control sub-circuit. As shown in FIG. 5B, in an exemplary implementation, when the writing signal terminal includes a data signal terminal Data and a reference signal terminal REF, the at least one scan signal terminal may include a fourth scan signal terminal Gate4 and a fifth scan signal terminal Gate5. The second node control sub-circuit is electrically connected to the fourth scan signal terminal Gate4, the fifth scan signal terminal Gate5, the second node N2, the voltage stabilizing signal terminal V, the reference signal terminal REF, and the data signal terminal Data, respectively.

In an exemplary implementation, as shown in FIG. 5B, the second node control sub-circuit may include a second capacitor C2, a third capacitor C3, a fourth transistor T4, and an eighth transistor T8. One terminal of the second capacitor C2 is electrically connected to the voltage stabilizing signal terminal V, and the other terminal of the second capacitor C2 is electrically connected to the second node N2. One terminal of the third capacitor C3 is electrically connected to the second node N2, and the other terminal of the third capacitor C3 is electrically connected to the fifth node N5. A control electrode of the fourth transistor T4 is electrically connected to the fourth scan signal terminal Gate4, a first electrode of the fourth transistor T4 is electrically connected to the reference signal terminal REF, and a second electrode of the fourth transistor T4 is electrically connected to the fifth node N5. A control electrode of the eighth transistor T8 is electrically connected to the fifth scan signal terminal Gate5, a first electrode of the eighth transistor T8 is electrically connected to the data signal terminal Data, and a second electrode of the eighth transistor T8 is electrically connected to the fifth node N5.

In an exemplary implementation, the third scan signal terminal Gate3, the fourth scan signal terminal Gate4, and the fifth scan signal terminal Gate5 are different signal terminals.

In the exemplary implementation, a time duration when the signal of the third scan signal terminal Gate3 is an effective level signal overlaps at least partially with a time duration when the signal of the fourth scan signal terminal Gate4 is an effective level signal and a time duration when the signal of the fifth scan signal terminal Gate5 is an effective level signal, respectively, and the time duration when the signal of the fourth scan signal terminal Gate4 is an effective level signal does not overlap with the time duration when the signal of the fifth scan signal terminal Gate5 is an effective level signal, wherein the third scan signal terminal Gate3 is electrically connected to the pixel driving circuit, and the fourth scan signal terminal Gate4 is electrically connected to the pixel driving circuit.

In the exemplary implementation, a time duration when the signal of the fourth scan signal terminal Gate4 is an effective level signal is within a time duration when the signal of the third scan signal terminal Gate3 is an effective level signal, and a time duration when the signal of the fifth scan signal terminal Gate5 is an effective level signal is within the time duration when the signal of the third scan signal terminal Gate3 is an effective level signal, wherein the fourth scan signal terminal Gate4 is electrically connected to the pixel driving circuit, the third scan signal terminal Gate3 is electrically connected to the pixel driving circuit, and the fifth scan signal terminal Gate5 is electrically connected to the pixel driving circuit.

In the exemplary implementation, a start time of the effective level signal at the third scan signal terminal Gate3 is a start time of the effective level signal at the fourth scan signal terminal Gate4, an end time of the effective level signal at the fourth scan signal terminal Gate4 is a start time of the effective level signal at the fifth scan signal terminal Gate5, and an end time of the effective level signal at the third scan signal terminal Gate3 is an end time of the effective level signal at the fifth scan signal terminal Gate5, wherein the third scan signal terminal Gate3, the fourth scan signal terminal Gate4 and the fifth scan signal terminal Gate5 are electrically connected to the pixel driving circuit.

In the exemplary implementation, a time duration when the signal of the first scan signal terminal Gate1 is an effective level signal overlaps at least partially with a time duration when the signal of the third scan signal terminal Gate3 is an effective level signal, and the time duration when the signal of the first scan signal terminal Gate1 is an effective level signal is within the time duration when the signal of the third scan signal terminal Gate3 is an effective level signal, wherein the first scan signal terminal Gate1 and the third scan signal terminal Gate3 are electrically connected to the pixel driving circuit.

In an exemplary implementation, a time duration when the signal of the first scan signal terminal Gate1 is an effective level signal overlaps at least partially with a time duration when the signal of the fourth scan signal terminal Gate4 is an effective level signal, wherein the first scan signal terminal Gate1 and the fourth scan signal terminal Gate4 are electrically connected to the pixel driving circuit.

In the exemplary implementation, a time duration when the signal of the first scan signal terminal Gate1 is an effective level signal coincides with a time duration when the signal of the fourth scan signal terminal Gate4 is an effective level signal, wherein the first scan signal terminal Gate1 and the fourth scan signal terminal Gate4 are electrically connected to the pixel driving circuit.

Two exemplary structures of the second node control sub-circuit are just shown in FIGS. 5A and 5B, and it will be readily understood by those skilled in the art that the implementation of the second node control sub-circuit is not limited thereto.

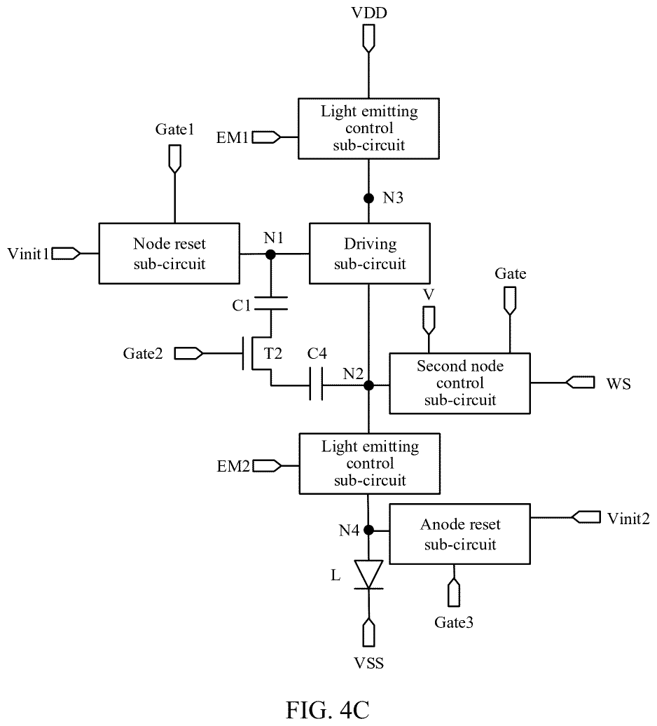

FIG. 6 is a partial equivalent circuit diagram of a pixel driving circuit. As shown in FIG. 6, in an exemplary implementation, a driving sub-circuit may include a third transistor T3. A control electrode of the third transistor T3 is electrically connected to the first node N1, a first electrode of the third transistor T3 is electrically connected to a third node N3, and a second electrode of the third transistor T3 is electrically connected to the second node N2. Herein, the third transistor T3 is a driving transistor.

One exemplary structure of the driving sub-circuit is just shown in FIG. 6, and it will be readily understood by those skilled in the art that the implementation of the driving sub-circuit is not limited thereto.

As shown in FIG. 6, in an exemplary implementation, a light emitting control sub-circuit may include: a fifth transistor T5 and a sixth transistor T6. A control electrode of the fifth transistor T5 is electrically connected to a first light emitting signal terminal EM1, a first electrode of the fifth transistor T5 is electrically connected to a first power terminal VDD, and a second electrode of the fifth transistor T5 is electrically connected to a third node N3; a control electrode of the sixth transistor T6 is electrically connected to a second light emitting signal terminal EM2, a first electrode of the sixth transistor T6 is electrically connected to a second node N2, and a second electrode of the sixth transistor T6 is electrically connected to a fourth node N4.

In an exemplary implementation, the pixel driving circuit is electrically connected to the first light emitting signal terminal EM1 and the second light emitting signal terminal EM2, the signal of the first light emitting signal terminal EM1 and the signal of the second light emitting signal terminal EM2 are simultaneously effective level signals for at least part of a time period, and are mutually inverse signals for at least another part of a time period.

One exemplary structure of the light emitting control sub-circuit is just shown in FIG. 6, and it will be readily understood by those skilled in the art that the implementation of the light emitting control sub-circuit is not limited thereto.

As shown in FIG. 6, in an exemplary implementation, the anode reset sub-circuit may include a seventh transistor T7. Herein, a control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4.

One exemplary structure of the anode reset sub-circuit is just shown in FIG. 6, and it will be readily understood by those skilled in the art that the implementation of the anode reset sub-circuit is not limited thereto.

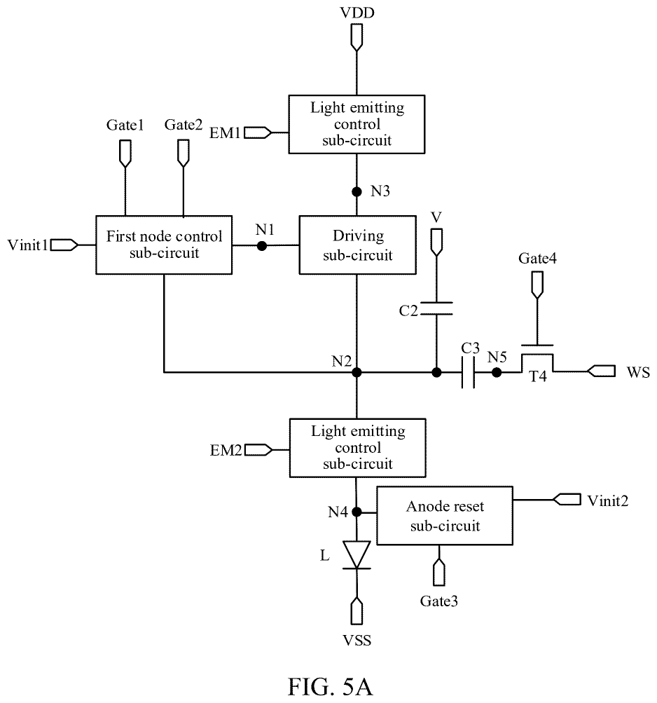

FIG. 7 is a first equivalent circuit diagram of a pixel driving circuit. As shown in FIG. 7, in an exemplary implementation, the first node control sub-circuit includes a first transistor T1, a second transistor T2, and a first capacitor C1; the second node control sub-circuit includes a fourth transistor T4, a second capacitor C2, and a third capacitor C3; the driving sub-circuit includes a third transistor T3; the light emitting control sub-circuit includes a fifth transistor T5 and a sixth transistor T6; and the anode reset sub-circuit includes a seventh transistor T7. A control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1. A control electrode of the second transistor T2 is electrically connected to the second scan signal terminal Gate2, and a second electrode of the second transistor T2 is electrically connected to the second node N2. A control electrode of the third transistor T3 is electrically connected to the first node N1, a first electrode of the third transistor T3 is electrically connected to a third node N3, and a second electrode of the third transistor T3 is electrically connected to the second node N2. A control electrode of the fourth transistor T4 is electrically connected to the fourth scan signal terminal Gate4, a first electrode of the fourth transistor T4 is electrically connected to the writing signal terminal WS, and a second electrode of the fourth transistor T4 is electrically connected to the fifth node N5. A control electrode of the fifth transistor T5 is electrically connected to the first light emitting signal terminal EM1, a first electrode of the fifth transistor T5 is electrically connected to the first power supply terminal VDD, and a second electrode of the fifth transistor T5 is electrically connected to the third node N3. A control electrode of the sixth transistor T6 is electrically connected to the second light emitting signal terminal EM2, a first electrode of the sixth transistor T6 is electrically connected to the second node N2, and a second electrode of the sixth transistor T6 is electrically connected to the fourth node N4. A control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4. One terminal of the first capacitor C1 is electrically connected to the first node N1, and the other terminal of the first capacitor C1 is electrically connected to a first electrode of the second transistor T2. One terminal of the second capacitor C2 is electrically connected to the voltage stabilizing signal terminal V, and the other terminal of the second capacitor C2 is electrically connected to the second node N2; one terminal of the third capacitor C3 is electrically connected to the second node N2, and the other terminal of the third capacitor C3 is electrically connected to the fifth node N5.

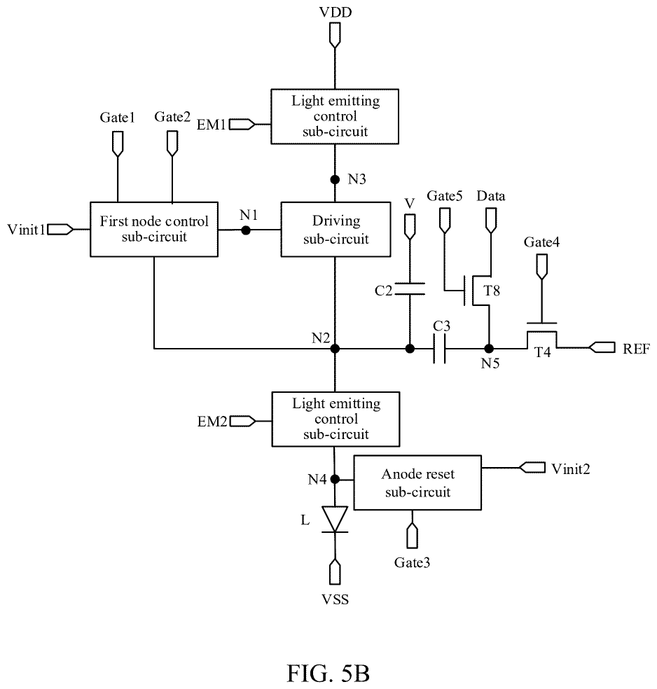

FIG. 8 is a second equivalent circuit diagram of the pixel driving circuit. As shown in FIG. 8, in an exemplary implementation, the first node control sub-circuit includes a first transistor T1, a second transistor T2, and a first capacitor C1; the second node control sub-circuit includes a fourth transistor T4, a second capacitor C2, and a third capacitor C3; the driving sub-circuit includes a third transistor T3; the light emitting control sub-circuit includes a fifth transistor T5 and a sixth transistor T6; and the anode reset sub-circuit includes a seventh transistor T7. A control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1. A control electrode of the second transistor T2 is electrically connected to a second scan signal terminal Gate2, a first electrode of the second transistor T2 is electrically connected to a first node N1. A control electrode of the third transistor T3 is electrically connected to the first node N1, a first electrode of the third transistor T3 is electrically connected to a third node N3, and a second electrode of the third transistor T3 is electrically connected to the second node N2. A control electrode of the fourth transistor T4 is electrically connected to the fourth scan signal terminal Gate4, a first electrode of the fourth transistor T4 is electrically connected to the writing signal terminal WS, and a second electrode of the fourth transistor T4 is electrically connected to the fifth node N5. A control electrode of the fifth transistor T5 is electrically connected to the first light emitting signal terminal EM1, a first electrode of the fifth transistor T5 is electrically connected to the first power supply terminal VDD, and a second electrode of the fifth transistor T5 is electrically connected to the third node N3. A control electrode of the sixth transistor T6 is electrically connected to the second light emitting signal terminal EM2, a first electrode of the sixth transistor T6 is electrically connected to the second node N2, and a second electrode of the sixth transistor T6 is electrically connected to the fourth node N4. A control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4. One terminal of the first capacitor C1 is electrically connected to the second node N2, and the other terminal of the first capacitor C1 is electrically connected to a second electrode of the second transistor T2. One terminal of the second capacitor C2 is electrically connected to the voltage stabilizing signal terminal V, and the other terminal of the second capacitor C2 is electrically connected to the second node N2. One terminal of the third capacitor C3 is electrically connected to the second node N2, and the other terminal of the third capacitor C3 is electrically connected to the fifth node N5.

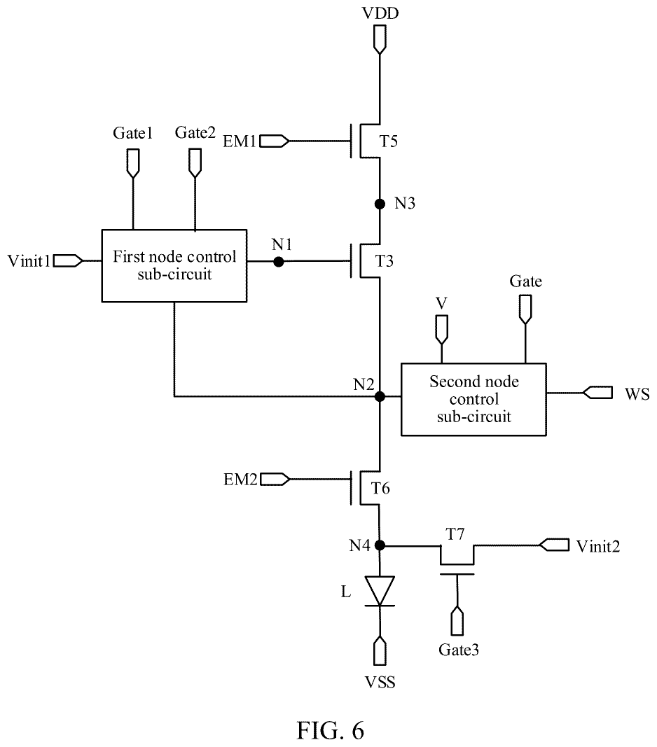

FIG. 9 is a third equivalent circuit diagram of the pixel driving circuit. As shown in FIG. 9, in an exemplary implementation, the first node control sub-circuit includes a first transistor T1, a second transistor T2, a first capacitor C1, and a fourth capacitor C4; the second node control sub-circuit includes a fourth transistor T4, a second capacitor C2, and a third capacitor C3; the driving sub-circuit includes a third transistor T3; the light emitting control sub-circuit includes a fifth transistor T5 and a sixth transistor T6; and the anode reset sub-circuit includes a seventh transistor T7. A control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1. A control electrode of the second transistor T2 is electrically connected to the second scan signal terminal Gate2. A control electrode of the third transistor T3 is electrically connected to the first node N1, a first electrode of the third transistor T3 is electrically connected to a third node N3, and a second electrode of the third transistor T3 is electrically connected to the second node N2. A control electrode of the fourth transistor T4 is electrically connected to the fourth scan signal terminal Gate4, a first electrode of the fourth transistor T4 is electrically connected to the writing signal terminal WS, and a second electrode of the fourth transistor T4 is electrically connected to the fifth node N5. A control electrode of the fifth transistor T5 is electrically connected to the first light emitting signal terminal EM1, a first electrode of the fifth transistor T5 is electrically connected to a first power supply terminal VDD, and a second electrode of the fifth transistor T5 is electrically connected to the third node N3. A control electrode of the sixth transistor T6 is electrically connected to the second light emitting signal terminal EM2, a first electrode of the sixth transistor T6 is electrically connected to the second node N2, and a second electrode of the sixth transistor T6 is electrically connected to a fourth node N4. A control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4. One terminal of the first capacitor C1 is electrically connected to the first node N1, and the other terminal of the first capacitor C1 is electrically connected to a first electrode of the second transistor T2. One terminal of the second capacitor C2 is electrically connected to the voltage stabilizing signal terminal V, and the other terminal of the second capacitor C2 is electrically connected to the second node N2. One terminal of the third capacitor C3 is electrically connected to the second node N2, and the other terminal of the third capacitor C3 is electrically connected to the fifth node N5. One terminal of the fourth capacitor C4 is electrically connected to the second node N2, and the other terminal of the fourth capacitor C4 is electrically connected to a second electrode of the second transistor T2.

In an exemplary implementation, in the pixel driving circuits provided in FIGS. 7 to 9, the first scan signal terminal Gate1 and the second scan signal terminal Gate2 may be the same signal terminal, and the third scan signal terminal Gate3 and the fourth scan signal terminal Gate4 may be the same signal terminal.

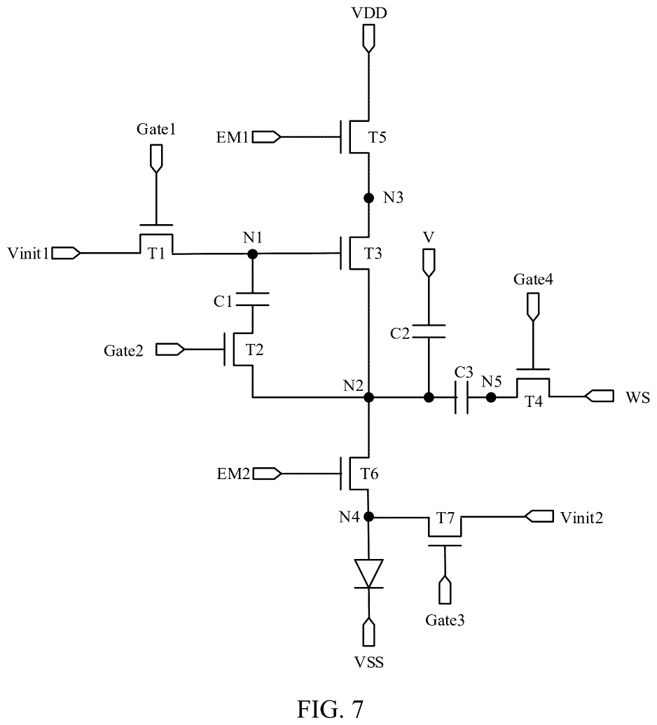

FIG. 10 is a fourth equivalent circuit diagram of the pixel driving circuit. As shown in FIG. 10, in an exemplary implementation, the first node control sub-circuit includes a first transistor T1, a second transistor T2, and a first capacitor C1; the second node control sub-circuit includes a fourth transistor T4, an eighth transistor T8, a second capacitor C2, and a third capacitor C3; the driving sub-circuit includes a third transistor T3; the light emitting control sub-circuit includes a fifth transistor T5 and a sixth transistor T6; and the anode reset sub-circuit includes a seventh transistor T7. A control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1. A control electrode of the second transistor T2 is electrically connected to the second scan signal terminal Gate2, and a second electrode of the second transistor T2 is electrically connected to the second node N2. A control electrode of the third transistor T3 is electrically connected to the first node N1, a first electrode of the third transistor T3 is electrically connected to a third node N3, and a second electrode of the third transistor T3 is electrically connected to the second node N2. A control electrode of the fourth transistor T4 is electrically connected to the fourth scan signal terminal Gate4, a first electrode of the fourth transistor T4 is electrically connected to the reference signal terminal REF, and a second electrode of the fourth transistor T4 is electrically connected to the fifth node N5. A control electrode of the fifth transistor T5 is electrically connected to the first light emitting signal terminal EM1, a first electrode of the fifth transistor T5 is electrically connected to the first power supply terminal VDD, and a second electrode of the fifth transistor T5 is electrically connected to the third node N3. A control electrode of the sixth transistor T6 is electrically connected to the second light emitting signal terminal EM2, a first electrode of the sixth transistor T6 is electrically connected to the second node N2, and a second electrode of the sixth transistor T6 is electrically connected to the fourth node N4. A control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4. A control electrode of the eighth transistor T8 is electrically connected to the fifth scan signal terminal Gate5, a first electrode of the eighth transistor T8 is electrically connected to the data signal terminal Data, and a second electrode of the eighth transistor T8 is electrically connected to the fifth node N5. One terminal of the first capacitor C1 is electrically connected to the first node N1, and the other terminal of the first capacitor C1 is electrically connected to a first electrode of the second transistor T2. One terminal of the second capacitor C2 is electrically connected to the voltage stabilizing signal terminal V, and the other terminal of the second capacitor C2 is electrically connected to the second node N2. One terminal of the third capacitor C3 is electrically connected to the second node N2, and the other terminal of the third capacitor C3 is electrically connected to the fifth node N5.

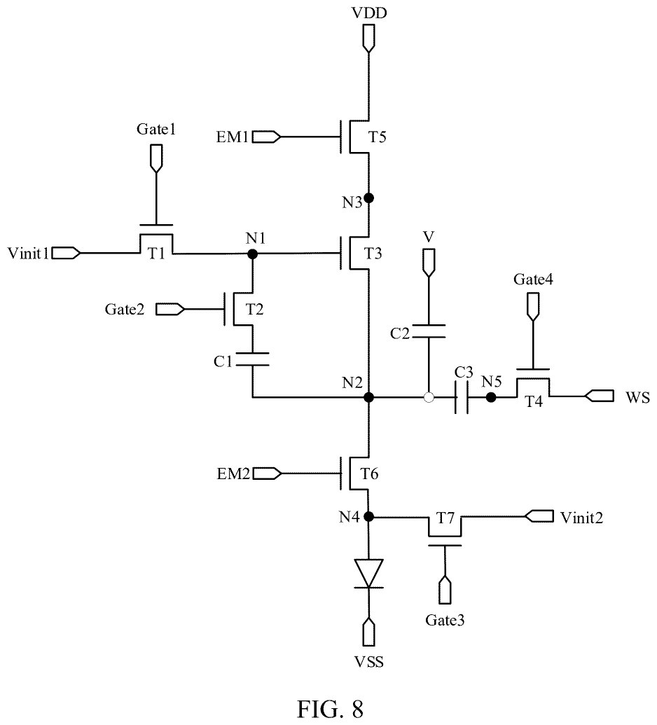

FIG. 11 is a fifth equivalent circuit diagram of the pixel driving circuit. As shown in FIG. 11, in an exemplary implementation, the first node control sub-circuit includes a first transistor T1, a second transistor T2, and a first capacitor C1; the second node control sub-circuit includes a fourth transistor T4, an eighth transistor T8, a second capacitor C2, and a third capacitor C3; the driving sub-circuit includes a third transistor T3; the light emitting control sub-circuit includes a fifth transistor T5 and a sixth transistor T6; and the anode reset sub-circuit includes a seventh transistor T7. A control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1. A control electrode of the second transistor T2 is electrically connected to the second scan signal terminal Gate2, a first electrode of the second transistor T2 is electrically connected to the first node N1. A control electrode of the third transistor T3 is electrically connected to the first node N1, a first electrode of the third transistor T3 is electrically connected to the third node N3, and a second electrode of the third transistor T3 is electrically connected to the second node N2. A control electrode of the fourth transistor T4 is electrically connected to the fourth scan signal terminal Gate4, a first electrode of the fourth transistor T4 is electrically connected to the reference signal terminal REF, and a second electrode of the fourth transistor T4 is electrically connected to the fifth node N5. A control electrode of the fifth transistor T5 is electrically connected to the first light emitting signal terminal EM1, a first electrode of the fifth transistor T5 is electrically connected to the first power supply terminal VDD, and a second electrode of the fifth transistor T5 is electrically connected to the third node N3. A control electrode of the sixth transistor T6 is electrically connected to the second light emitting signal terminal EM2, a first electrode of the sixth transistor T6 is electrically connected to the second node N2, and a second electrode of the sixth transistor T6 is electrically connected to the fourth node N4. A control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4. A control electrode of the eighth transistor T8 is electrically connected to the fifth scan signal terminal Gate5, a first electrode of the eighth transistor T8 is electrically connected to the data signal terminal Data, and a second electrode of the eighth transistor T8 is electrically connected to the fifth node N5. One terminal of the first capacitor C1 is electrically connected to the second node N2, and the other terminal of the first capacitor C1 is electrically connected to a second electrode of the second transistor T2. One terminal of the second capacitor C2 is electrically connected to the voltage stabilizing signal terminal V, and the other terminal of the second capacitor C2 is electrically connected to the second node N2. One terminal of the third capacitor C3 is electrically connected to the second node N2, and the other terminal of the third capacitor C3 is electrically connected to the fifth node N5.

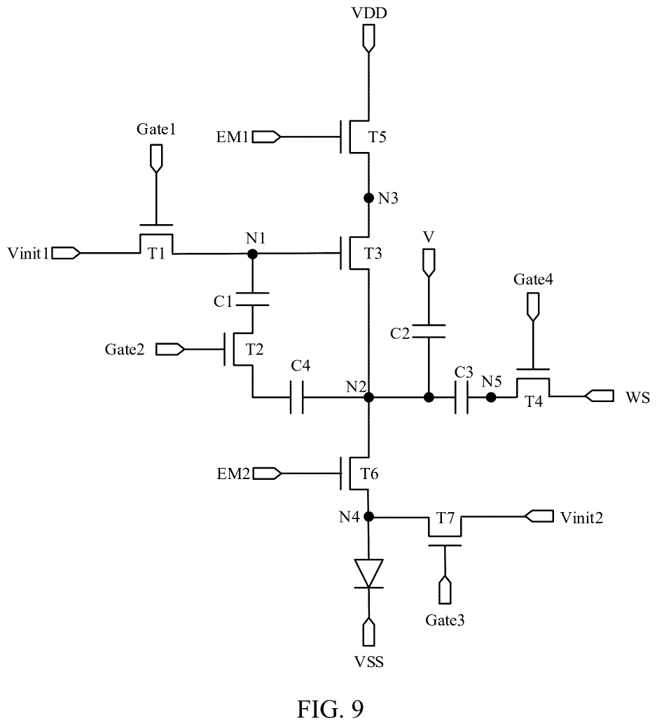

FIG. 12 is a sixth equivalent circuit diagram of the pixel driving circuit. As shown in FIG. 12, in an exemplary implementation, the first node control sub-circuit includes a first transistor T1, a second transistor T2, a first capacitor C1, and a fourth capacitor C4; the second node control sub-circuit includes a fourth transistor T4, an eighth transistor T8, a second capacitor C2, and a third capacitor C3; the driving sub-circuit includes a third transistor T3; the light emitting control sub-circuit includes a fifth transistor T5 and a sixth transistor T6; and the anode reset sub-circuit includes a seventh transistor T7. A control electrode of the first transistor T1 is electrically connected to the first scan signal terminal Gate1, a first electrode of the first transistor T1 is electrically connected to the first initial signal terminal Vinit1, and a second electrode of the first transistor T1 is electrically connected to the first node N1. A control electrode of the second transistor T2 is electrically connected to the second scan signal terminal Gate2. A control electrode of the third transistor T3 is electrically connected to the first node N1, a first electrode of the third transistor T3 is electrically connected to the third node N3, and a second electrode of the third transistor T3 is electrically connected to the second node N2. A control electrode of the fourth transistor T4 is electrically connected to the fourth scan signal terminal Gate4, a first electrode of the fourth transistor T4 is electrically connected to the reference signal terminal REF, and a second electrode of the fourth transistor T4 is electrically connected to the fifth node N5. A control electrode of the fifth transistor T5 is electrically connected to the first light emitting signal terminal EM1, a first electrode of the fifth transistor T5 is electrically connected to the first power supply terminal VDD, and a second electrode of the fifth transistor T5 is electrically connected to the third node N3. A control electrode of the sixth transistor T6 is electrically connected to the second light emitting signal terminal EM2, a first electrode of the sixth transistor T6 is electrically connected to the second node N2, and a second electrode of the sixth transistor T6 is electrically connected to the fourth node N4. A control electrode of the seventh transistor T7 is electrically connected to the third scan signal terminal Gate3, a first electrode of the seventh transistor T7 is electrically connected to the second initial signal terminal Vinit2, and a second electrode of the seventh transistor T7 is electrically connected to the fourth node N4. A control electrode of the eighth transistor T8 is electrically connected to the fifth scan signal terminal Gate5, a first electrode of the eighth transistor T8 is electrically connected to the data signal terminal Data, and a second electrode of the eighth transistor T8 is electrically connected to the fifth node N5. One terminal of the first capacitor C1 is electrically connected to the first node N1, and the other terminal of the first capacitor C1 is electrically connected to a first electrode of the second transistor T2. One terminal of the second capacitor C2 is electrically connected to the voltage stabilizing signal terminal V, and the other terminal of the second capacitor C2 is electrically connected to the second node N2. One terminal of the third capacitor C3 is electrically connected to the second node N2, and the other terminal of the third capacitor C3 is electrically connected to the fifth node N5. One terminal of the fourth capacitor C4 is electrically connected to the second node N2, and the other terminal of the fourth capacitor C4 is electrically connected to the second electrode of the second transistor T2.

Transistors may be divided into N-type transistors and P-type transistors according to their characteristics. When a transistor is a P-type transistor, its turn-on voltage is a low-level voltage (e.g., 0V, −5 V, −10 V, or another suitable voltage), and its turn-off voltage is a high-level voltage (e.g., 5 V, 10 V, or another suitable voltage). When a transistor is an N-type transistor, its turn-on voltage is a high-level voltage (e.g., 5 V, 10 V, or another suitable voltage), and its turn-off voltage is a low-level voltage (e.g., 0 V, −5 V, −10 V, or another suitable voltage).

In an exemplary implementation, the N-type transistor may be an oxide thin film transistor. An active layer of the oxide thin film transistor is made of an oxide semiconductor (Oxide). The oxide thin film transistor has advantages such as a low drain current.

In an exemplary implementation, the pixel driving circuit includes a plurality of transistors, and at least one transistor in the pixel driving circuit is the N-type transistor.

In an exemplary implementation, in the pixel driving circuits provided in FIGS. 7 to 9, the first transistor T1 to the seventh transistor T7 may be N-type transistors.

The pixel driving circuit is provided in a display substrate, and contents displayed on the display substrate include a plurality of display frames.

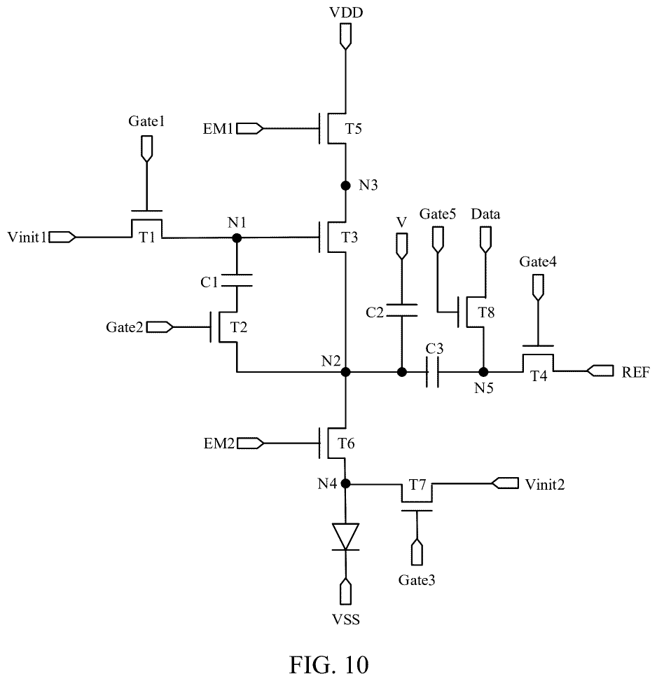

In an exemplary implementation, FIG. 13 is an operating timing diagram of the pixel driving circuits provided in FIGS. 7 to 9. As shown in FIG. 13, in at least one display frame, the pixel driving circuit operates in a first period t1 to a fourth period t4.

As shown in FIG. 13, in the first period t1, signals of the second light emitting signal terminal EM2, the first scan signal terminal Gate1, the second scan signal terminal Gate2, the third scan signal terminal Gate3, and the fourth scan signal terminal Gate4 are effective level signals, and a signal of the first light emitting signal terminal EM1 is ineffective level signal.

As shown in FIG. 13, in the second period t2, signals of the first light emitting signal terminal EM1, the first scan signal terminal Gate1, the second scan signal terminal Gate2, the third scan signal terminal Gate3, and the fourth scan signal terminal Gate4 are effective level signals, and a signal of the second light emitting signal terminal EM2 is ineffective level signal. As shown in FIG. 13, in the third period t3, signals of the third scan signal terminal Gate3 and the fourth scan signal terminal Gate4 are effective level signals, and signals of the first scan signal terminal Gate1, the second scan signal terminal Gate2, the first light emitting signal terminal EM1, and the second light emitting signal terminal EM2 are ineffective level signals. As shown in FIG. 13, in the fourth period t4, signals of the first light emitting signal terminal EM1 and the second light emitting signal terminal EM2 are effective level signals, and signals of the first scan signal terminal Gate1, the second scan signal terminal Gate2, the third scan signal terminal Gate3, and the fourth scan signal terminal Gate4 are ineffective level signals.

In an exemplary implementation, the writing signal terminal WS is the reference signal terminal in the first period t1, the second period t2, and the fourth period t4.

In an exemplary implementation, the writing signal terminal WS is the data signal terminal in the third period t3.

In an exemplary implementation, in the pixel driving circuits provided in FIGS. 10 to 12, the first transistor T1 to the eighth transistor T8 may be N-type transistors.

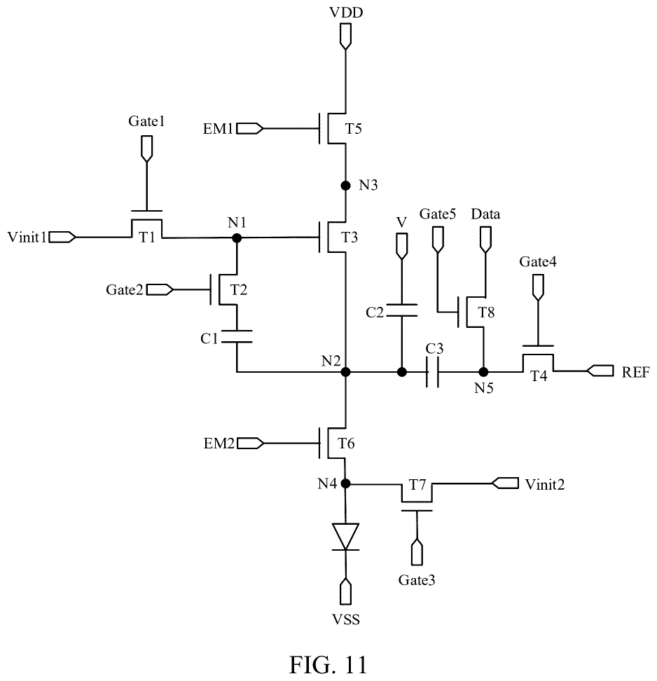

In an exemplary implementation, FIG. 14 is an operating timing diagram of the pixel driving circuits provided in FIGS. 10 to 12. As shown in FIG. 14, in at least one display frame, the pixel driving circuit operates in a first period t1 to a fourth period t4.

As shown in FIG. 14, in the first period t1, signals of the second light emitting signal terminal EM2, the first scan signal terminal Gate1, the second scan signal terminal Gate2, the third scan signal terminal Gate3, and the fourth scan signal terminal Gate4 are effective level signals, and signals of the first light emitting signal terminal EM1 and the fifth scan signal terminal Gate5 are ineffective level signals.

As shown in FIG. 14, in the second period t2, signals of the first light emitting signal terminal EM1, the first scan signal terminal Gate1, the second scan signal terminal Gate2, and the third scan signal terminal Gate3 are effective level signals, and signals of the second light emitting signal terminal EM2 and the fifth scan signal terminal Gate5 are ineffective level signals.

As shown in FIG. 14, in the third period t3, signals of the third scan signal terminal Gate3 and the fifth scan signal terminal Gate5 are effective level signals, and signals of the first scan signal terminal Gate1, the second scan signal terminal Gate2, the fourth scan signal terminal Gate4, the first light emitting signal terminal EM1, and the second light emitting signal terminal EM2 are ineffective level signals.

As shown in FIG. 14, in the fourth period t4, signals of the first light emitting signal terminal EM1 and the second light emitting signal terminal EM2 are effective level signals, and signals of the first scan signal terminal Gate1, the second scan signal terminal Gate2, the third scan signal terminal Gate3, the fourth scan signal terminal Gate4, and the fifth scan signal terminal Gate5 are ineffective level signals.

As shown in FIGS. 13 and 14, a stage of the first period t1 is a first stage P1, a stage of the second period t2 is a second stage P2, a stage of the third period t3 is a third stage P3, and a stage of the fourth period t4 is a fourth stage P4.

The exemplary embodiment of the present disclosure will be described below by a working process of the pixel driving circuits exemplified in FIGS. 7 to 9, the pixel driving circuits in FIGS. 7 to 9 include seven transistors (the first transistor T1 to the seventh transistor T7), the pixel driving circuits in FIGS. 7 and 8 include three capacitors (the first capacitor C1 to the third capacitor C3), and the pixel driving circuit in FIG. 9 includes four capacitors (the first capacitor C1 to the fourth capacitor C4), all of the seven transistors are N-type transistors.

In an exemplary implementation, the working process of the pixel driving circuits provided in FIGS. 7 to 9 may include following stages.

In the first stage P1, i.e., an initialization stage, the signals of the second light emitting signal terminal EM2, the first scan signal terminal Gate1, the second scan signal terminal Gate2, the third scan signal terminal Gate3, and the fourth scan signal terminal Gate4 are high-level signals, and the signal of the first light emitting signal terminal EM1 is a low-level signal. In this stage, the writing signal terminal WS is the reference signal terminal. The signal of the first scan signal terminal Gate1 is a high level signal, the first transistor T1 is turned on, the signal of the first initial signal terminal Vinit1 is written to the first node N1, to initialize (reset) the signal of the first node N1, and clear the original charges in the first node N1. The voltage value V1 of the signal of the first node N1 is equal to Vini1, wherein Vini1 is the voltage value of the signal of the first initial signal terminal Vinit1. Since the voltage value of the signal of the first node N1 and the voltage value of the signal of the third node N3 are greater than the threshold voltage of the third transistor T3, in this stage, the third transistor T3 is turned on. The signal of the third scan signal terminal Gate3 is a high-level signal, the seventh transistor T7 is turned on, the signal of the second initial signal terminal Vinit2 is written to the fourth node N4, to initialize (reset) the signal of the fourth node N4, and clear the original charges in the fourth node N4. The voltage value V4 of the signal of the fourth node N4 is equal to Vini2, wherein Vini2 is the voltage value of the signal of the second initial signal terminal Vinit2. The signals of the second scan signal terminal Gate2 and the second light emitting signal terminal EM2 are high-level signals, the second transistor T2 and the sixth transistor T6 are turned on, in this stage, the third transistor T3 is turned on, the signal of the second initial signal terminal Vinit2 is written to the second node N2 and the third node N3, to initialize (reset) the signals of the second node N2 and the third node N3, and clear the original charges in the second node N2 and the third node N3. The voltage value V2 of the signal of the second node N2 is equal to Vini2, and the voltage value V3 of the signal of the third node N3 is equal to Vini2. The signal of the fourth scan signal terminal Gate4 is a high-level signal, the fourth transistor T4 is turned on, the signal of the reference signal terminal is written to the fifth node N5, to initialize (reset) the signal of the fifth node N5, and clear the original charges in the fifth node N5. The voltage value V5 of the signal of the fifth node N5 is equal to Vref, Vref is the voltage value of the signal of the reference signal terminal. The signal of the first light emitting signal terminal EM1 is a low level signal, and the fifth transistor T5 is turned off. The light emitting device L does not emit light in this stage.

In the second stage P2, i.e., a threshold compensation stage, the signals of the first light emitting signal terminal EM1, the first scan signal terminal Gate1, the second scan signal terminal Gate2, the third scan signal terminal Gate3, and the fourth scan signal terminal Gate4 are high-level signals, and the signal of the second light emitting signal terminal EM2 is a low-level signal. In this stage, the writing signal terminal WS is the reference signal terminal. The signal of the first scan signal terminal Gate1 continues to be a high-level signal, the first transistor T1 continues to be turned on, and the signal of the first initial signal terminal Vinit1 continues to be written to the first node N1, to initialize (reset) the signal of the first node N1, and clear the original charges in the first node N1. The voltage value V1 of the signal of the first node N1 is equal to Vini1. The signal of the third scan signal terminal Gate3 continues to be a high-level signal, the seventh transistor T7 continues to be turned on, and the signal of the second initial signal terminal Vinit2 continues to be written to the fourth node N4, to initialize (reset) the signal of the fourth node N4, and clear the original charges in the fourth node N4. The voltage value V4 of the signal of the fourth node N4 is equal to Vini2, wherein Vini2 is the voltage value of the signal of the second initial signal terminal Vinit2. The signals of the second scan signal terminal Gate2 and the first light emitting signal terminal EM1 are high-level signals, the second transistors T2 and the fifth transistors T5 are turned on, and the signal of the first power supply terminal VDD is written to the other terminal of the first capacitor C1 and the second node N2 by the turned-on fifth transistor T5, the turned-on third transistor T3 and the turned-on second transistor T2, until the voltage V2 of the signal of the second node N2 is equal to Vini1−Vth. The voltage value V3 of the signal of the third node N3 is equal to Vdd, wherein Vdd is the voltage value of the first power supply terminal VDD. At this time, the first capacitor C1 stores the voltage difference Vth between the signals of the first node N1 and the second node N2. The signal of the fourth scan signal terminal Gate4 continues to be a high-level signal, the fourth transistor T4 continues to be turned on, the signal of the reference signal terminal continues to be written to the fifth node N5, to initialize (reset) the signal of the fifth node N5, and clear the original charges in the fifth node N5. The voltage value V5 of the signal of the fifth node N5 is equal to Vref. The signal of the second light emitting signal terminal EM2 is a low level signal, and the sixth transistor T6 is turned off. The light emitting device L does not emit light in this stage.

In the third stage P3, i.e., a data writing stage, the signals of the third scan signal terminal Gate3 and the fourth scan signal terminal Gate4 are high-level signals, and the signals of the first scan signal terminal Gate1, the second scan signal terminal Gate2, the first light emitting signal terminal EM1, and the second light emitting signal terminal EM2 are low-level signals. In this stage, the writing signal terminal WS is a data signal terminal, and the data signal terminal outputs a data voltage. The signal of the third scan signal terminal Gate3 continues to be a high-level signal, the seventh transistor T7 continues to be turned on, and the signal of the second initial signal terminal Vinit2 continues to be written to the fourth node N4, to initialize (reset) the signal of the fourth node N4, and clear the original charges in the fourth node N4. The voltage value V4 of the signal of the fourth node N4 is equal to Vini2. The signal of the fourth scan signal terminal Gate4 is a high-level signal, the fourth transistor T4 is turned on, and the data voltage of the data signal terminal Data is written to the fifth node N5. At this time, the voltage value V5 of the fifth node N5 is equal to Vdata, Vdata is the data voltage, and the signal of the fifth node N5 jumps from the voltage value Vref of the previous stage to the voltage value Vdata of the present stage. Therefore, under the coupling effect of the second capacitor C2 and the third capacitor C3, the signal of the second node N2 also jumps. At this time, the voltage value V2 of the signal of the second node N2 satisfies V2=Vini1−Vth+(Vdata−Vref)*(C3/(C2+C3)), wherein C2 is the capacitance value of the second capacitor C2, and C3 is the capacitance value of the third capacitor C3. The signals of the first scan signal terminal Gate1, the second scan signal terminal Gate2, the first light emitting signal terminal EM1, and the second light emitting signal terminal EM2 are low-level signals, and the first transistor T1, the second transistor T2, the fifth transistor T5, and the sixth transistor T6 are turned off. The signal of the previous stage thereof is maintained at the first node N1, and the signal of the previous stage thereof is maintained at the third node N3. The light emitting device L does not emit light in this stage.

In the fourth stage P4, i.e., a light-emitting stage, the signals of the first light emitting signal terminal EM1 and the second light emitting signal terminal EM2 are high-level signals, and the signals of the first scan signal terminal Gate1, the second scan signal terminal Gate2, the third scan signal terminal Gate3, and the fourth scan signal terminal Gate4 are low-level signals. In this stage, the writing signal terminal WS is the reference signal terminal. The signals of the first light emitting signal terminal EM1 and the second light emitting signal terminal EM2 are high-level signals, the fifth transistor T5 and the sixth transistor T6 are turned on, and a power supply voltage outputted by the first power supply terminal VDD provides a drive voltage to a first electrode of the light emitting device L through the turned-on fifth transistor T5, third transistor T3 and sixth transistor T6, to drive the light emitting device L to emit light. The signals of the first scan signal terminal Gate1, the second scan signal terminal Gate2, the third scan signal terminal Gate3, and the fourth scan signal terminal Gate4 are low-level signals, and the first transistor T1, the second transistor T2, the fourth transistor T4, and the seventh transistor T7 are turned off. The signal of the previous stage thereof is maintained at the first node N1, and at the present stage, the light emitting device L emits light. In a drive process of the pixel driving circuit, the driving current flowing through the third transistor T3 (a driving transistor) is determined by a voltage difference between the control electrode (also the first node N1) and the second electrode (also the second node N2) of the third transistor T3. Since the voltage value V1 of the signal of the first node N1 satisfies V1=Vini1 and the voltage value V2 of the signal of the second node N2 satisfies V2=Vini1−Vth+(Vdata−Vref)*(C3/(C2+C3)), the voltage difference Vgs between the control electrode and the second electrode of the third transistor T3 satisfies:

Vgs=V1−V2=Vth+(vref−vdata)*(C₃/(C₂+C₃))

Therefore, the driving current I of the third transistor T3 satisfies:

I=K*(Vgs−Vth)²=K*[(C₃/(C₂+C₃)*(Vref−Vdata)]²

Herein, the driving current flowing through the third transistor T3 is also the driving current which drives the light emitting device L, and K is a constant.

It can be seen from the derivation result of the above current formula that in the light emitting stage, the driving current of the third transistor T3 is not affected by the threshold voltage of the third transistor T3. Therefore, the influence of the threshold voltage of the third transistor T3 on the driving current is eliminated, which can ensure uniformity of the display brightness of the display product, and improve the overall display effect of the display product.

The exemplary embodiment of the present disclosure will be described below by a working process of the pixel driving circuits exemplified in FIGS. 10 to 12, the pixel driving circuits in FIGS. 10 to 12 include eight transistors (the first transistor T1 to the eighth transistor T8), the pixel driving circuits in FIGS. 10 and 11 include three capacitors (the first capacitor C1 to the third capacitor C3), and the pixel driving circuit in FIG. 12 includes four capacitors (the first capacitor C1 to the fourth capacitor C4), all of the eight transistors are N-type transistors.

In an exemplary implementation, the working process of the pixel driving circuits provided in FIGS. 10 to 12 may include following stages.

In the first stage P1, i.e., a initialization stage, the signals of the second light emitting signal terminal EM2, the first scan signal terminal Gate1, the second scan signal terminal Gate2, the third scan signal terminal Gate3, and the fourth scan signal terminal Gate4 are high-level signals, and the signals of the first light emitting signal terminal EM1 and the fifth scan signal terminal Gate5 are low-level signals. The signal of the first scan signal terminal Gate1 is a high level signal, the first transistor T1 is turned on, and the signal of the first initial signal terminal Vinit1 is written to the first node N1, to initialize (reset) the signal of the first node N1, and clear the original charges in the first node N1. The voltage value V1 of the signal of the first node N1 is equal to Vini1, wherein Vini1 is the voltage value of the signal of the first initial signal terminal Vinit1. Since the voltage value of the signal of the first node N1 and the voltage value of the signal of the third node N3 are greater than the threshold voltage of the third transistor T3, in this stage, the third transistor T3 is turned on. The signal of the third scan signal terminal Gate3 is a high-level signal, the seventh transistor T7 is turned on, and the signal of the second initial signal terminal Vinit2 is written to the fourth node N4, to initialize (reset) the signal of the fourth node N4, and clear the original charges in the fourth node N4. The voltage value V4 of the signal of the fourth node N4 is equal to Vini2, wherein Vini2 is the voltage value of the signal of the second initial signal terminal Vinit2. The signals of the second scan signal terminal Gate2 and the second light emitting signal terminal EM2 are high-level signals, the second transistor T2 and the sixth transistor T6 are turned on, in this stage, the third transistor T3 is turned on, and the signal of the second initial signal terminal Vinit2 is written to the second node N2 and the third node N3, to initialize (reset) the signals of the second node N2 and the third node N3, and clear the original charges in the second node N2 and the third node N3. The voltage value V2 of the signal of the second node N2 is equal to Vini2, and the voltage value V3 of the signal of the third node N3 is equal to Vini2. The signal of the fourth scan signal terminal Gate4 is a high-level signal, the fourth transistor T4 is turned on, and the signal of the reference signal terminal REF is written to the fifth node N5, to initialize (reset) the signal of the fifth node N5, and clear the original charges in the fifth node N5. The voltage value V5 of the signal of the fifth node N5 is equal to Vref, Vref is the voltage value of the signal of the reference signal terminal REF. The signals of the first light emitting signal terminal EM1 and the fifth scan signal terminal Gate5 are low-level signals, and the fifth transistor T5 and the eighth transistor T8 are turned off. The light emitting device L does not emit light in this stage.

In the second stage P2, i.e., a threshold compensation stage, the signals of the first light emitting signal terminal EM1, the first scan signal terminal Gate1, the second scan signal terminal Gate2, the third scan signal terminal Gate3 and the fourth scan signal terminal Gate4 are high-level signals, and the signals of the second light emitting signal terminal EM2 and the fifth scan signal terminal Gate5 are low-level signals. The signal of the first scan signal terminal Gate1 continues to be a high-level signal, the first transistor T1 continues to be turned on, and the signal of the first initial signal terminal Vinit1 continues to be written to the first node N1, to initialize (reset) the signal of the first node N1, and clear the original charges in the first node N1. The voltage value V1 of the signal of the first node N1 is equal to Vini1. The signal of the third scan signal terminal Gate3 continues to be a high-level signal, the seventh transistor T7 continues to be turned on, and the signal of the second initial signal terminal Vinit2 continues to be written to the fourth node N4, to initialize (reset) the signal of the fourth node N4, and clear the original charges in the fourth node N4. The voltage value V4 of the signal of the fourth node N4 is equal to Vini2, wherein Vini2 is the voltage value of the signal of the second initial signal terminal Vinit2. The signals of the second scan signal terminal Gate2 and the first light emitting signal terminal EM1 are high-level signals, the second transistors T2 and the fifth transistors T5 are turned on, and the signal of the first power supply terminal VDD is written to the other terminal of the first capacitor C1 and the second node N2 by the turned-on fifth transistor T5, the turned-on third transistor T3 and the turned-on second transistor T2, until the voltage V2 of the signal of the second node N2 is equal to Vini1−Vth. The voltage value V3 of the signal of the third node N3 is equal to Vdd, wherein Vdd is the voltage value of the first power supply terminal VDD. At this time, the first capacitor C1 stores the voltage difference Vth between the signals of the first node N1 and the second node N2. The signal of the fourth scan signal terminal Gate4 continues to be a high-level signal, the fourth transistor T4 continues to be turned on, and the signal of the reference signal terminal REF continues to be written to the fifth node N5, to initialize (reset) the signal of the fifth node N5, and clear the original charges in the fifth node N5. The voltage value V5 of the signal of the fifth node N5 is equal to Vref. The signals of the second light emitting signal terminal EM2 and the fifth scan signal terminal Gate5 are low-level signals, and the sixth transistor T6 and the eighth transistor T8 are turned off. The light emitting device L does not emit light in this stage.

In the third stage P3, i.e., a data writing stage, the signals of the third scan signal terminal Gate3 and the fifth scan signal terminal Gate5 are high-level signals, and the signals of the first scan signal terminal Gate1, the second scan signal terminal Gate2, the fourth scan signal terminal Gate4, the first light emitting signal terminal EM1, and the second light emitting signal terminal EM2 are low-level signals. In this stage, the data signal terminal Data outputs a data voltage. The signal of the third scan signal terminal Gate3 continues to be a high-level signal, the seventh transistor T7 continues to be turned on, and the signal of the second initial signal terminal Vinit2 continues to be written to the fourth node N4, to initialize (reset) the signal of the fourth node N4, and clear the original charges in the fourth node N4. The voltage value V4 of the signal of the fourth node N4 is equal to Vini2. The signal of the fifth scan signal terminal Gate5 is a high-level signal, the eighth transistor T8 is turned on, and the data voltage of the data signal terminal Data is written to the fifth node N5. At this time, the voltage value V5 of the fifth node N5 is equal to Vdata, Vdata is the data voltage, and the signal of the fifth node N5 jumps from the voltage value Vref of the previous stage to the voltage value Vdata of the present stage. Therefore, under the coupling effect of the second capacitor C2 and the third capacitor C3, the signal of the second node N2 also jumps. At this time, the voltage value V2 of the signal of the second node N2 satisfies V2=Vini1−Vth+(Vdata−Vref)*(C3/(C2+C3)), wherein C2 is the capacitance value of the second capacitor C2, and C3 is the capacitance value of the third capacitor C3. The signals of the first scan signal terminal Gate1, the second scan signal terminal Gate2, the fourth scan signal terminal Gate4, the first light emitting signal terminal EM1, and the second light emitting signal terminal EM2 are low-level signals, and the first transistor T1, the second transistor T2, the fourth transistor T4, the fifth transistor T5, and the sixth transistor T6 are turned off. The signal of the previous stage thereof is maintained, and the signal of the previous stage thereof is maintained. The light emitting device L does not emit light in this stage.

In the fourth stage P4, i.e., the light-emitting stage, the signals of the first light emitting signal terminal EM1 and the second light emitting signal terminal EM2 are high-level signals, and the signals of the first scan signal terminal Gate1, the second scan signal terminal Gate2, the third scan signal terminal Gate3, the fourth scan signal terminal Gate4, and the fifth scan signal terminal Gate5 are low-level signals. The signals of the first light emitting signal terminal EM1 and the second light emitting signal terminal EM2 are high-level signals, the fifth transistor T5 and the sixth transistor T6 are turned on, and a power supply voltage outputted by the first power supply terminal VDD provides a drive voltage to a first electrode of the light emitting device L through the turned-on fifth transistor T5, third transistor T3 and sixth transistor T6, to drive the light emitting device L to emit light. The signals of the first scan signal terminal Gate1, the second scan signal terminal Gate2, the third scan signal terminal Gate3, the fourth scan signal terminal Gate4, and the fifth scan signal terminal Gate5 are low-level signals, and the first transistor T1, the second transistor T2, the fourth transistor T4, the seventh transistor T7, and the eighth transistor T8 are turned off. The signal of the previous stage thereof is maintained at the first node N1, and in the present stage, the light emitting device L emits light.

In a drive process of the pixel driving circuit, the driving current flowing through the third transistor T3 (a driving transistor) is determined by a voltage difference between the control electrode (also the first node N1) and the second electrode (also the second node N2) of the third transistor T3. Since the voltage value V1 of the signal of the first node N1 satisfies V1=Vini1 and the voltage value V2 of the signal of the second node N2 satisfies V2=Vini1−Vth+(Vdata−Vref)*(C₃/(C₂+C₃), the voltage difference Vgs between the control electrode and the second electrode of the third transistor T3 satisfies:

Vgs=V1−V2=Vth+(vref−vdata)*(C₃/(C₂+C₃))

Therefore, the driving current I of the third transistor T3 satisfies:

I=K*(Vgs−Vth)²=K*[(C₃/(C₂+C₃)*(Vref−Vdata)]²

Herein, the driving current flowing through the third transistor T3 is also the driving current which drives the light emitting device L, and K is a constant.

It can be seen from the derivation result of the above current formula that in the light emitting stage, the driving current of the third transistor T3 is not affected by the threshold voltage of the third transistor T3. Therefore, the influence of the threshold voltage of the third transistor T3 on the driving current is eliminated, which can ensure uniformity of the display brightness of the display product, and improve the overall display effect of the display product.

According to the above analysis, it can be seen that in the present disclosure the signal of the second node N2 is controlled by setting the second capacitor C2 and the third capacitor C3 in the second node control sub-circuit, and the coupling effect of the second capacitor C2 and the third capacitor C3, so that the driving current satisfies: I=K*[(C₃/(C₂+C₃)*(Vref−Vdata)]², thus the stability of the driving current of the pixel driving circuit is guaranteed.

An embodiment of the present disclosure also provides a driving method of the pixel driving circuit configured to drive the pixel driving circuit provided by any of the above embodiments, and the driving method of the pixel driving circuit may include the following acts 100 to 300.

In act 100, under control of signals of the first scan signal terminal and the second scan signal terminal, the first node control sub-circuit provides a signal of the first initial signal terminal to the first node, and changes a signal of the first node by a signal of the second node.

In act 200, the second node control sub-circuit changes the signal of the second node by a signal of the writing signal terminal under control of a signal of at least one scan signal terminal.

In act 300, the driving sub-circuit provides a driving signal to the second node under control of signals of the first node and the third node.

In an exemplary implementation, the driving method of the pixel driving circuit may further include the following acts 400 and 500.

In act 400, under control of a signal of the third scan signal terminal, the anode reset sub-circuit provides a signal of the second initial signal terminal to the fourth node.

In act 500, the light emitting control sub-circuit provides a signal of the first power supply terminal to the third node and provides the signal of the second node to the fourth node under control of signals of the first light emitting signal terminal and the second light emitting signal terminal.

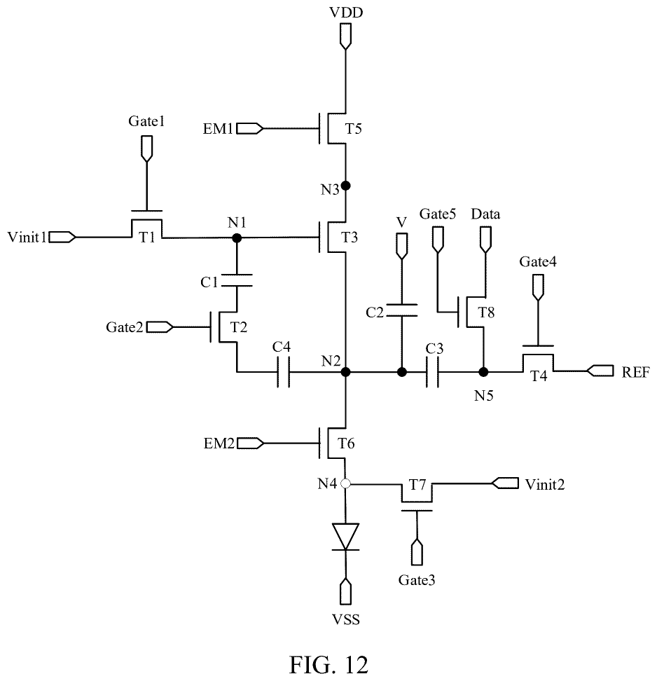

FIG. 15 is a schematic diagram of a structure of a display apparatus. As shown in FIG. 15, an embodiment of the present disclosure also provides a display apparatus having a display region, wherein a plurality of pixel driving circuits P are provided in the display region.

In an exemplary implementation, as shown in FIG. 15, the display apparatus may include a timing controller, a data driving circuit, a scan driving circuit and a pixel array. The timing controller is electrically connected to the data driving circuit and the scan driving circuit respectively, the data driving circuit is electrically connected to the plurality of data signal lines D respectively, and the scan driving circuit is electrically connected to the plurality of scan signal lines G respectively. The pixel array may include a plurality of sub-pixels, at least one sub-pixel may include a circuit unit and a light emitting device electrically connected to a circuit unit, and the circuit unit may include a pixel driving circuit which may be electrically connected to the scan signal line and the data signal line, respectively. Herein, the scan signal line is electrically connected to at least one scan signal terminal and at least one light emitting signal terminal that are electrically connected to the pixel driving circuit, respectively. A data signal point is electrically connected to the data signal terminal electrically connected to the pixel driving circuit.

In an exemplary implementation, the timing controller may provide a gray-scale value and a control signal suitable for a specification of the data driving circuit to the data driving circuit, may provide a clock signal, a scan start signal, etc., suitable for a specification of the scan driving circuit to the scan driving circuit, and may provide a clock signal, an emission stop signal, etc., suitable for a specification of the light emitting driving circuit to the light emitting driving circuit.

In an exemplary implementation, the data driving circuit may generate a data voltage to be provided to the data signal lines using the gray-scale value and the control signal received from the timing controller. For example, the data driving circuit may sample the gray-scale value using a clock signal, and apply a data voltage corresponding to the gray-scale value to the data signal line by taking a pixel row as a unit.

In an exemplary implementation, the scan driving circuit may generate scan signals to be provided to the scan signal lines by receiving the clock signal, the scan start signal, or the like, from the timing controller. For example, the scan driving circuit may sequentially provide a scan signal with an on-level pulse to scan signal lines. For example, the scan driving circuit may be constructed in a form of a shift register, and may generate a scan signal in a manner of sequentially transmitting a scan start signal provided in a form of an on-level pulse to a next-stage circuit under control of a clock signal.

In an exemplary implementation, the display apparatus may include a plurality of pixel units arranged in a matrix, at least one of the plurality of pixel units includes a first sub-pixel emitting light of a first color, a second sub-pixel emitting light of a second color, and a third sub-pixel emitting light of a third color, and the first sub-pixel, the second sub-pixel, and the third sub-pixel each includes a pixel circuit and a light emitting device. Pixel driving circuits in the first sub-pixel, the second sub-pixel, and the third sub-pixel are respectively electrically connected to a scan signal line and a data signal line. The pixel driving circuit is configured to receive a data voltage transmitted by the data signal line and output a corresponding current to the light emitting device under control of at least one scan signal line. Light emitting devices in the first sub-pixel, the second sub-pixel, and the third sub-pixel are respectively electrically connected to the pixel driving circuit of the sub-pixel in which the light emitting device is located, and the light emitting device is configured to emit light with a corresponding brightness in response to a current outputted by the pixel driving circuit of the sub-pixel in which the light emitting device is located.

In exemplary implementations, the sub-pixel may have a shape of a rectangle, a rhombus, a pentagon, or a hexagon.

In an exemplary implementation, the first sub-pixel may be a red (R) sub-pixel emitting red light, the second sub-pixel may be a blue (B) sub-pixel emitting blue light, and the third sub-pixel may be a green (G) sub-pixel emitting green light.

In an exemplary implementation, a pixel unit may include three sub-pixels, and the three sub-pixels may be arranged side by side horizontally, side by side vertically, or in a manner like a Chinese character “ [symbol] ”, and the present disclosure is not limited herein.

In an exemplary implementation, a pixel unit may include four sub-pixels, and the four sub-pixels may be arranged side by side horizontally, side by side vertically, or in a shape of a square, which is not limited here in the present disclosure.

The display apparatus may include a driving structure layer disposed on a substrate, a light-emitting structure layer disposed on a side of the driving structure layer away from the substrate, and an encapsulation structure layer disposed on a side of the light-emitting structure layer away from the substrate. In some possible implementations, the display apparatus may include another film layer, such as a touch structure layer, which is not limited here in the present disclosure.

In an exemplary implementation, the base substrate may be a rigid base substrate or a flexible base substrate, wherein the rigid base substrate may be, but is not limited to, one or more of glass and conductive foil. The flexible base substrate may be, but is not limited to, one or more of polyethylene terephthalate, ethylene terephthalate, polyether ether ketone, polystyrene, polycarbonate, polyarylate, polyarylester, polyimide, polyvinyl chloride, polyethylene, and textile fiber.

In an exemplary implementation, the driving structure layer may include a plurality of transistors and a storage capacitor forming a pixel driving circuit, and the light emitting structure layer may include an anode, a pixel definition layer, an organic light emitting layer, and a cathode, the anode is electrically connected to a drain electrode of the transistor therein through a via, the organic light emitting layer is electrically connected to the anode, and the cathode is electrically connected to the organic light emitting layer, and the organic light emitting layer emits light of a corresponding color under drive of the anode and the cathode.

In an exemplary implementation, the encapsulation structure layer may include a first encapsulation layer, a second encapsulation layer, and a third encapsulation layer that are stacked. The first encapsulation layer and the third encapsulation layer may be made of an inorganic material, and the second encapsulation layer may be made of an organic material. The second encapsulation layer is disposed between the first encapsulation layer and the third encapsulation layer, which may ensure that external water vapor cannot enter the light emitting structure layer.

In an exemplary implementation, the touch structure layer may include a first touch insulation layer disposed on the encapsulation structure layer, a first touch metal layer disposed on the first touch insulation layer, a second touch insulation layer covering the first touch metal layer, a second touch metal layer disposed on the second touch insulation layer, and a touch protective layer covering the second touch metal layer. The first touch metal layer may include a plurality of bridge electrodes, the second touch metal layer may include a plurality of first touch electrodes and second touch electrodes, and a first touch electrode or second touch electrode may be electrically connected to a bridge electrode through a via.

In an exemplary implementation, the scan driving circuit is electrically connected to a first scan signal terminal, a second scan signal terminal, a third scan signal terminal, a first light emitting signal terminal, and a second light emitting signal terminal that are electrically connected to the pixel driving circuit, respectively; and the scan driving circuit is configured to provide an effective level signal to the second light emitting signal terminal, the first scan signal terminal, the second scan signal terminal, and the third scan signal terminal, and provide an ineffective level signal to the first light emitting signal terminal, in a first time period; provide an effective level signal to the first light emitting signal terminal, the first scan signal terminal, the second scan signal terminal, and the third scan signal terminal, and provide an ineffective level signal to the second light emitting signal terminal, in a second time period; provide an effective level signal to the third scan signal terminal, and provide an ineffective level signal to the first light emitting signal terminal, the second light emitting signal terminal, the first scan signal terminal and the second scan signal terminal, in a third time period; and provide an effective level signal to the first light emitting signal terminal and the second light emitting signal terminal, and provide an ineffective level signal to the first scan signal terminal, the second scan signal terminal and the third scan signal terminal, in a fourth time period. The first time period to the fourth time period lapse sequentially, and at least two time periods from the first time period to the fourth time period do not overlap.

In an exemplary implementation, an end time of the first time period is a start time of the second time period, an end time of the second time period is a start time of the third time period, and an end time of the third time period is a start time of the fourth time period.

In an exemplary implementation, the scan driving circuit is also electrically connected to a fourth scan signal terminal which is electrically connected to the pixel driving circuit, and the scan driving circuit is configured to: provide an effective level signal to the fourth scan signal terminal during the first time period to the third time period, and provide an ineffective level signal to the fourth scan signal terminal during the fourth time period.

In an exemplary implementation, the scan driving circuit is further electrically connected to a fourth scan signal terminal and a fifth scan signal terminal which are electrically connected to the pixel driving circuit, respectively; and the scan driving circuit is configured to provide an effective level signal to the fourth scan signal terminal, and provide an ineffective level signal to the fifth scan signal terminal, in the first and second time periods; provide an effective level signal to the fifth scan signal terminal, and provide an ineffective level signal to the fourth scan signal terminal, in the third time period; and provide an ineffective level signal to the fourth scan signal terminal and the fifth scan signal terminal in the fourth time period.

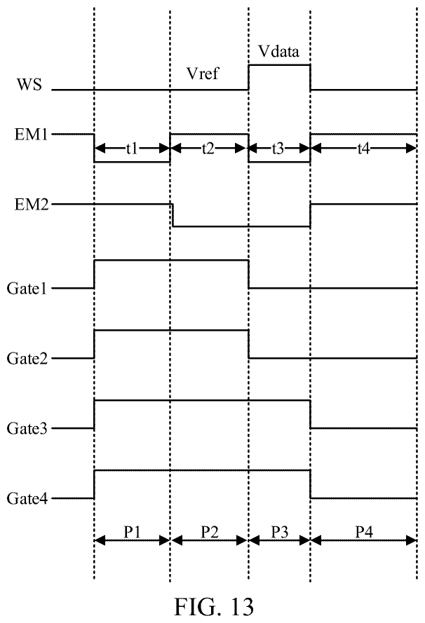

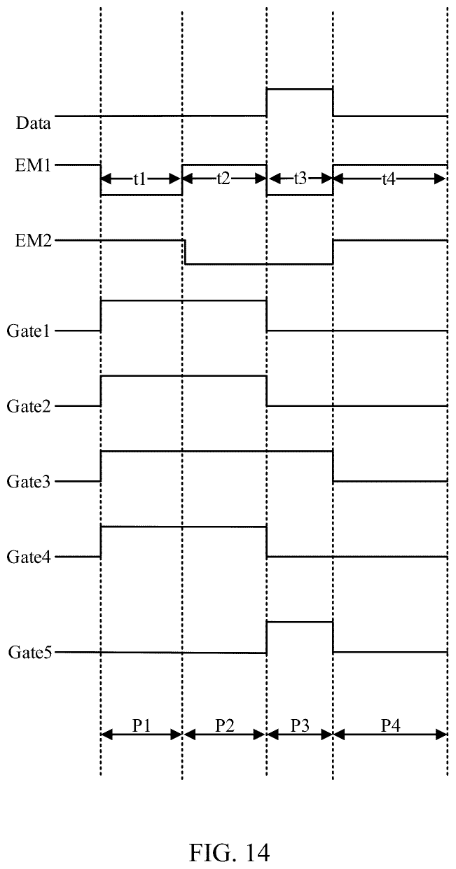

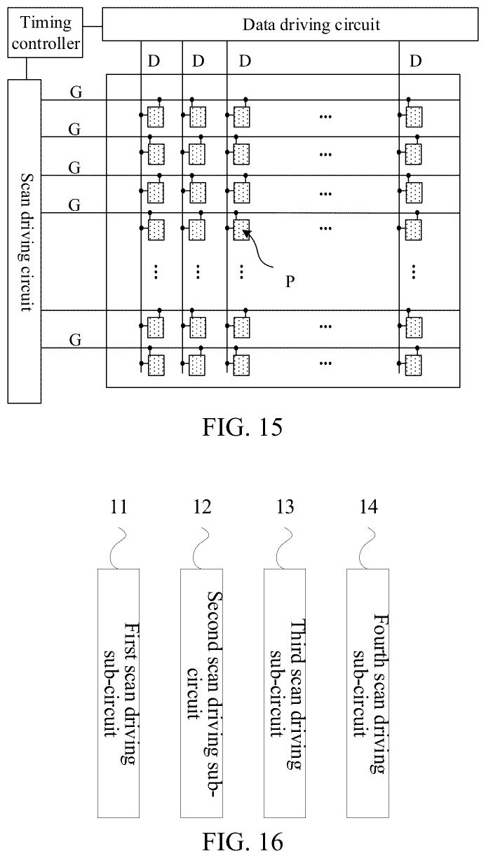

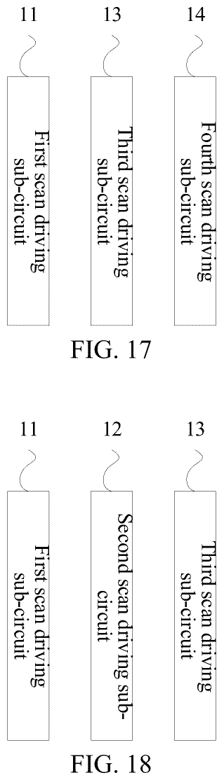

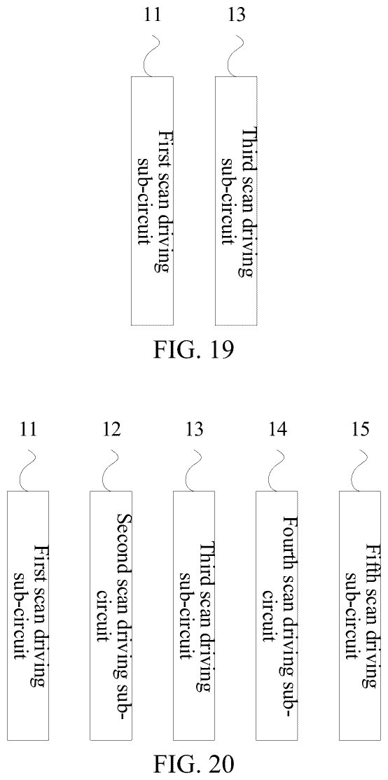

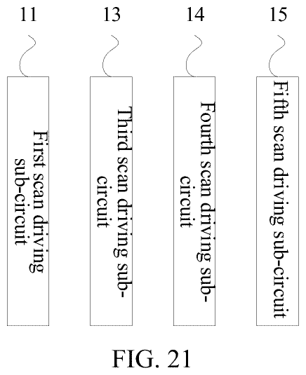

In exemplary implementations, FIG. 16 is a first schematic diagram of the scan driving circuit, FIG. 17 is a second schematic diagram of the scan driving circuit, FIG. 18 is a third schematic diagram of the scan driving circuit, FIG. 19 is a fourth schematic diagram of the scan driving circuit, FIG. 20 is a fifth schematic diagram of the scan driving circuit, FIG. 21 is a sixth schematic diagram of the scan driving circuit. The scan driving circuit includes at least one scan driving sub-circuit.

In an exemplary implementation, as shown in FIGS. 16, 18 and 20, when the first scan signal terminal and the second scan signal terminal electrically that are connected to the pixel driving circuit are different signal terminals, the scan driving circuit may include a first scan driving sub-circuit 11 and a second scan driving sub-circuit 12. Herein, the first scan driving sub-circuit 11 is electrically connected to the first scan signal terminal, and the second scan driving sub-circuit 12 is electrically connected to the second scan signal terminal.

In an exemplary implementation, as shown in FIGS. 17, 19 and 21, when the first scan signal terminal and the second scan signal terminal that are electrically connected to the pixel driving circuit are the same signal terminal, the scan driving circuit includes a first scan driving sub-circuit 11. Herein, the first scan driving sub-circuit 11 is electrically connected to the first scan signal terminal and the second scan signal terminal, respectively.

In an exemplary implementation, as shown in FIGS. 16 and 17, at least one scan signal terminal electrically connected to the second node control sub-circuit is a fourth scan signal terminal, and when the third scan signal terminal and the fourth scan signal terminal that are electrically connected to the pixel driving circuit are different signal terminals, the scan driving circuit includes a third scan driving sub-circuit 13 and a fourth scan driving sub-circuit 14. Herein, the third scan driving sub-circuit 13 is electrically connected to the third scan signal terminal, and the fourth scan driving sub-circuit 14 is electrically connected to the fourth scan signal terminal.

In an exemplary implementation, as shown in FIGS. 18 and 19, at least one scan signal terminal electrically connected to the second node control sub-circuit is a fourth scan signal terminal, and when the third scan signal terminal and the fourth scan signal terminal that are electrically connected to the pixel driving circuit are a same signal terminal, the scan driving circuit includes a third scan driving sub-circuit 13. Herein, the third scan driving sub-circuit 13 is electrically connected to the third scan signal terminal and the fourth scan signal terminal, respectively.

In an exemplary implementation, as shown in FIGS. 20 and 21, when at least one scan signal terminal electrically connected to the second node control sub-circuit is the fourth scan signal terminal and the fifth scan signal terminal, the scan driving circuit includes a third scan driving sub-circuit 13, a fourth scan driving sub-circuit 14, and a fifth scan driving sub-circuit 15. Herein, the third scan driving sub-circuit 13 is electrically connected to the third scan signal terminal, the fourth scan driving sub-circuit 14 is electrically connected to the fourth scan signal terminal, and the fifth scan driving sub-circuit 15 is electrically connected to the fifth scan signal terminal.

In an exemplary implementation, the display apparatus may be any product or component with a display function, such as a mobile phone, a tablet computer, a television, a display, a laptop computer, a digital photo frame, or a navigator, and the embodiments of the present invention are not limited thereto.

The drawings of the embodiments of the present disclosure only involve structures involved in the embodiments of the present disclosure, and other structures may refer to a general design.

For the sake of clarity, a thickness and size of a layer or a micro structure are enlarged in the accompanying drawings used for describing the embodiments of the present disclosure. It may be understood that when an element such as a layer, film, region, or substrate is described as being “on” or “under” another element, the element may be “directly” located “on” or “under” the another element, or there may be an intermediate element.

Although the implementations of the present disclosure are disclosed above, the contents are only implementations used for ease of understanding of the present disclosure, but not intended to limit the present disclosure. Any of those skilled in the art of the present disclosure can make any modifications and variations in the implementation mode and details without departing from the spirit and scope of the present disclosure. However, the protection scope of the present disclosure should be subject to the scope defined by the appended claims

1. A pixel driving circuit, comprising: a first node control sub-circuit, a second node control sub-circuit and a driving sub-circuit;
wherein the driving sub-circuit is electrically connected to a first node, a second node, and a third node respectively, and is configured to provide a driving signal to the second node under control of signals of the first node and the third node;
the first node control sub-circuit is electrically connected to a first scan signal terminal, a second scan signal terminal, a first initial signal terminal, the first node and the second node, respectively, and is configured to provide a signal of the first initial signal terminal to the first node under control of signals of the first scan signal terminal and the second scan signal terminal, and change a signal of the first node by a signal of the second node;
the second node control sub-circuit is electrically connected to at least one scan signal terminal, the second node, a voltage stabilizing signal terminal and a writing signal terminal respectively, and is configured to change the signal of the second node by a signal of the writing signal terminal under control of signals of the at least one scan signal terminal and the voltage stabilizing signal terminal;
the writing signal terminal comprises a data signal terminal and a reference signal terminal, or the writing signal terminal is a data signal terminal in at least a part of a time period, and is a reference signal terminal in at least another part of a time period; and
the first node control sub-circuit comprises at least one capacitor, the second node control sub-circuit comprises at least two capacitors and at least one transistor, and the at least one capacitor in the first node control sub-circuit is electrically connected to the at least one transistor in the second node control sub-circuit by at least one capacitor in the second node control sub-circuit.

2. The pixel driving circuit of claim 1, further comprising an anode reset sub-circuit and a light emitting control sub-circuit;
wherein the anode reset sub-circuit is electrically connected to a third scan signal terminal, a second initial signal terminal and a fourth node respectively, and is configured to provide a signal of the second initial signal terminal to the fourth node under control of a signal of the third scan signal terminal; and
the light emitting control sub-circuit is electrically connected to a first light emitting signal terminal, a second light emitting signal terminal, a first power supply terminal, the second node, the third node, and the fourth node respectively, and is configured to provide a signal of the first power supply terminal to the third node and a signal of the second node to the fourth node under control of signals of the first light emitting signal terminal and the second light emitting signal terminal.

3. The pixel driving circuit of claim 1, wherein the first node control sub-circuit comprises a node reset sub-circuit and a node compensation sub-circuit;
the node reset sub-circuit is electrically connected to the first scan signal terminal, the first initial signal terminal and the first node respectively, and is configured to provide a signal of the first initial signal terminal to the first node under control of a signal of the first scan signal terminal; and
the node compensation sub-circuit is electrically connected to the first node, the second node and the second scan signal terminal respectively, and is configured to change the signal of the first node by the signal of the second node under control of the signal of the second scan signal terminal.

4. The pixel driving circuit of claim 3, wherein the node reset sub-circuit comprises a first transistor;
a control electrode of the first transistor is electrically connected to the first scan signal terminal, a first electrode of the first transistor is electrically connected to the first initial signal terminal, and a second electrode of the first transistor is electrically connected to the first node.

5. The pixel driving circuit of claim 3, wherein the node compensation sub-circuit comprises a first capacitor and a second transistor;
one terminal of the first capacitor is electrically connected to the first node, and the other terminal of the first capacitor is electrically connected to a first electrode of the second transistor; and
a control electrode of the second transistor is electrically connected to the second scan signal terminal, and a second electrode of the second transistor is electrically connected to the second node;
or
wherein the node compensation sub-circuit comprises a first capacitor and a second transistor;
one terminal of the first capacitor is electrically connected to the second node, and the other terminal of the first capacitor is electrically connected to a second electrode of the second transistor; and
a control electrode of the second transistor is electrically connected to the second scan signal terminal, and a first electrode of the second transistor is electrically connected to the first node;
or
wherein the node compensation sub-circuit comprises a first capacitor, a second transistor, and a fourth capacitor;
one terminal of the first capacitor is electrically connected to the first node, and the other terminal of the first capacitor is electrically connected to a first electrode of the second transistor;
one terminal of the fourth capacitor is electrically connected to the second node, and the other terminal of the fourth capacitor is electrically connected to a second electrode of the second transistor; and
a control electrode of the second transistor is electrically connected to the second scan signal terminal.

6-7. (canceled)

8. The pixel driving circuit of claim 3, wherein the first scan signal terminal and the second scan signal terminal are different signal terminals or are a same signal terminal.

9. The pixel driving circuit of claim 1, wherein when the writing signal terminal is a data signal terminal in at least a part of the time period and a reference signal terminal in at least another part of the time period, the at least one scan signal terminal comprises a fourth scan signal terminal, and the second node control sub-circuit is respectively connected to the fourth scan signal terminal, the second node, the voltage stabilizing signal terminal and the writing signal terminal.

10. The pixel driving circuit of claim 9, wherein the second node control sub-circuit comprises a second capacitor, a third capacitor, and a fourth transistor;
one terminal of the second capacitor is electrically connected to the voltage stabilizing signal terminal, and the other terminal of the second capacitor is electrically connected to the second node;
one terminal of the third capacitor is electrically connected to the second node, and the other terminal of the third capacitor is electrically connected to the fifth node; and
a control electrode of the fourth transistor is electrically connected to the fourth scan signal terminal, a first electrode of the fourth transistor is electrically connected to the writing signal terminal, and a second electrode of the fourth transistor is electrically connected to the fifth node.

11. The pixel driving circuit of claim 9, wherein the third scan signal terminal and the fourth scan signal terminal are different signal terminals or are a same signal terminal.

12. The pixel driving circuit of claim 1, wherein when the writing signal terminal comprises a data signal terminal and a reference signal terminal, the at least one scan signal terminal comprises a fourth scan signal terminal and a fifth scan signal terminal, and the second node control sub-circuit is electrically connected to the fourth scan signal terminal, the fifth scan signal terminal, the second node, the voltage stabilizing signal terminal, the reference signal terminal and the data signal terminal, respectively.

13. The pixel driving circuit of claim 12, wherein the second node control sub-circuit comprises a second capacitor, a third capacitor, a fourth transistor, and an eighth transistor;
one terminal of the second capacitor is electrically connected to the voltage stabilizing signal terminal, and the other terminal of the second capacitor is electrically connected to the second node;
one terminal of the third capacitor is electrically connected to the second node, and the other terminal of the third capacitor is electrically connected to the fifth node;
a control electrode of the fourth transistor is electrically connected to the fourth scan signal terminal, a first electrode of the fourth transistor is electrically connected to the reference signal terminal, and a second electrode of the fourth transistor is electrically connected to the fifth node; and
a control electrode of the eighth transistor is electrically connected to the fifth scan signal terminal, a first electrode of the eighth transistor is electrically connected to the data signal terminal, and a second electrode of the eighth transistor is electrically connected to the fifth node.

14. The pixel driving circuit of claim 13, wherein the third scan signal terminal, the fourth scan signal terminal, and the fifth scan signal terminal are different signal terminals.

15. The pixel driving circuit of claim 2, wherein the driving sub-circuit comprises a third transistor, the light emitting control sub-circuit comprises a fifth transistor and a sixth transistor, and the anode reset sub-circuit comprises a seventh transistor;
a control electrode of the third transistor is electrically connected to the first node, a first electrode of the third transistor is electrically connected to the third node, and a second electrode of the third transistor is electrically connected to the second node;
a control electrode of the fifth transistor is electrically connected to the first light emitting signal terminal, a first electrode of the fifth transistor is electrically connected to the first power supply terminal, and a second electrode of the fifth transistor is electrically connected to the third node;
a control electrode of the sixth transistor is electrically connected to the second light emitting signal terminal, a first electrode of the sixth transistor is electrically connected to the second node, and a second electrode of the sixth transistor is electrically connected to the fourth node; and
a control electrode of the seventh transistor is electrically connected to the third scan signal terminal, a first electrode of the seventh transistor is electrically connected to the second initial signal terminal, and a second electrode of the seventh transistor is electrically connected to the fourth node.

16. (canceled)

17. A display apparatus, comprising the pixel driving circuit of claim 1.

18. The display apparatus of claim 17, further comprising: a scan driving circuit, wherein the scan driving circuit is respectively electrically connected to the first scan signal terminal, the second scan signal terminal, a third scan signal terminal, a first light emitting signal terminal and a second light emitting signal terminal electrically connected to the pixel driving circuit, and the scan driving circuit is configured to: provide an effective level signal to the second light emitting signal terminal, the first scan signal terminal, the second scan signal terminal, and the third scan signal terminal, and provide an ineffective level signal to the first light emitting signal terminal, in a first time period; provide an effective level signal to the first light emitting signal terminal, the first scan signal terminal, the second scan signal terminal, and the third scan signal terminal, and provide an ineffective level signal to the second light emitting signal terminal, in a second time period; provide an effective level signal to the third scan signal terminal, and provide an ineffective level signal to the first light emitting signal terminal, the second light emitting signal terminal, the first scan signal terminal and the second scan signal terminal, in a third time period; and provide an effective level signal to the first light emitting signal terminal and the second light emitting signal terminal, and provide an ineffective level signal to the first scan signal terminal, the second scan signal terminal and the third scan signal terminal, in a fourth time period;
wherein the first time period to the fourth time period lapse sequentially, and at least two time periods from the first time period to the fourth time period do not overlap.

19. The display apparatus of claim 18, wherein an end time of the first time period is a start time of the second time period, an end time of the second time period is a start time of the third time period, and an end time of the third time period is a start time of the fourth time period.

20. The display apparatus of claim 18, wherein the scan driving circuit is further electrically connected to a fourth scan signal terminal electrically connected to the pixel driving circuit, and the scan driving circuit is configured to: provide an effective level signal to the fourth scan signal terminal in the first time period to third time period, and provide an ineffective level signal to the fourth scan signal terminal in the fourth time period;
or
the scan driving circuit is further respectively electrically connected to a fourth scan signal terminal and a fifth scan signal terminal electrically connected to the pixel driving circuit, and the scan driving circuit is configured to: provide an effective level signal to the fourth scan signal terminal, and provide an ineffective level signal to the fifth scan signal terminal, in the first and second time periods; provide an effective level signal to the fifth scan signal terminal, and provide an ineffective level signal to the fourth scan signal terminal, in the third time period; and provide an ineffective level signal to the fourth scan signal terminal and the fifth scan signal terminal in the fourth time period.

21. (canceled)

22. The display apparatus of claim 18, wherein when the first scan signal terminal and the second scan signal terminal electrically connected to the pixel driving circuit are different signal terminals, the scan driving circuit comprises a first scan driving sub-circuit and a second scan driving sub-circuit;
the first scan driving sub-circuit is electrically connected to the first scan signal terminal, and the second scan driving sub-circuit is electrically connected to the second scan signal terminal;
or
wherein when the first scan signal terminal and the second scan signal terminal electrically connected to the pixel driving circuit are a same signal terminal, the scan driving circuit comprises a first scan driving sub-circuit;
the first scan driving sub-circuit is electrically connected to the first scan signal terminal and the second scan signal terminal respectively.

23. (canceled)

24. The display apparatus of claim 22, wherein at least one scan signal terminal electrically connected to the second node control sub-circuit is a fourth scan signal terminal, and when the third scan signal terminal and the fourth scan signal terminal electrically connected to the pixel driving circuit are different signal terminals, the scan driving circuit comprises a third scan driving sub-circuit and a fourth scan driving sub-circuit;
the third scan driving sub-circuit is electrically connected to the third scan signal terminal, and the fourth scan driving sub-circuit is electrically connected to the fourth scan signal terminal;
or
wherein at least one scan signal terminal electrically connected to the second node control sub-circuit is a fourth scan signal terminal, and when the third scan signal terminal and the fourth scan signal terminal electrically connected to the pixel driving circuit are a same signal terminal, the scan driving circuit comprises a third scan driving sub-circuit;
the third scan driving sub-circuit is electrically connected to the third scan signal terminal and the fourth scan signal terminal respectively;
or
wherein when at least one scan signal terminal electrically connected to the second node control sub-circuit is a fourth scan signal terminal and a fifth scan signal terminal, the scan driving circuit comprises a third scan driving sub-circuit, a fourth scan driving sub-circuit and a fifth scan driving sub-circuit;
the third scan driving sub-circuit is electrically connected to the third scan signal terminal, the fourth scan driving sub-circuit is electrically connected to the fourth scan signal terminal, and the fifth scan driving sub-circuit is electrically connected to the fifth scan signal terminal.

25-26. (canceled)

27. A driving method for a pixel driving circuit, configured to drive the pixel driving circuit according to claim 1, the method comprising:
providing, by the first node control sub-circuit, the signal of the first initial signal terminal to the first node under the control of the signals of the first scan signal terminal and the second scan signal terminal, and changing the signal of the first node by the signal of the second node;
changing, by the second node control sub-circuit, the signal of the second node by the signal of the writing signal terminal under the control of the signal of the at least one scan signal terminal; and
providing, by the driving sub-circuit, the driving signal to the second node under the control of the signals of the first node and the third node.

28. (canceled)
